(19) United States
(12) Patent Application Publication
(10) Pub. No.: US 2008/0046298 A1
(43) Pub. Date: Feb. 21, 2008

(54) System and Method For Travel Planning

(76) Inventors: Ziv Ben-Yehuda, Rishon Lezion (IL); Nir Yaron, Petach Tikva (IL); Tal Shem-Tov, Petach Tikva (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/572,823

(22) PCT Filed: Jul. 31, 2005
(86) PCT No.: PCT/IL05/00814

§ 371 Date: Jan. 29, 2007

Related U.S. Application Data
(60) Provisional application No. 60/591,866, filed on Jul. 29, 2004.
(60) Provisional application No. 60/611,459, filed on Sep. 20, 2004.

(51) Int. Cl. G01C 21/34

(52) U.S. Cl. 705/6

(57) ABSTRACT

Methods, systems and computer readable code for travel planning are provided. According to some embodiments, a travel planning engine schedules a plurality of activities within one or more time intervals and generates a travel plan, where each activity is associated with a physical location and optional time parameters. Alternatively or additionally, the travel planning is implemented by receiving manual travel planning directives through a user interface. According to some embodiments, the activities are scheduled so as to satisfy specific constraints and/or travel benefit parameters. According to some embodiments, the travel plan includes information about traveling between relevant locations. Some embodiments of the present invention include a method of comparing and/or presenting a plurality of travel options, wherein each travel option is associated with a respective mode of transportation. Some embodiments of the present invention provide a system, method or computer readable code for customizing a travel itinerary for a traveler. Some embodiments of the present invention provide a system, method or computer readable code for presenting information about pricing of at least three targeted travel services on a single screen including a plurality of distinct bundling combinations.

### FIELD OF THE INVENTION

The present invention described relates to a system and to method for planning of travel, recreational activities and/or tourism activities.

### BACKGROUND OF THE INVENTION

The traveling public relies upon sources such as travel books, brochures, maps, travel agents, and the worldwide web for information on various travel-related subjects such as hotels, restaurants, attractions and transportation. Obtaining this information in advance of a trip requires time-consuming planning and preparation. By their nature, printed books and brochures are heavy and occupy part of the limited luggage space available to the traveler. Furthermore, information in books is frequently out-of-date and updates require re-printing and dissemination. Incomplete or outdated information may waste precious time, increase costs and cause aggravation. Efficient and correct planning may make or break a person's trip. For instance, inefficient planning may ignore the location of attractions and cause people to travel back and forth, wasting their time and money. Incorrect or outdated information may result in planning a visit to a museum on a day closed to the public or past visiting hours.

There is an ongoing need for improved systems for travel planning. In particular, there is an ongoing need for systems for scheduling recreational and/or tourism activities within one or more given time periods. Preferably, such systems would be operative to schedule the recreational and/or tourism activity in accordance with relevant travel parameters, e.g. budget parameters, distances and/or travel time between the various recreational and/or tourism activities, and opening hours of certain attractions, availability of transportation between recreational and/or tourism activities. Such systems would relieve the tourist from the burden of trip planning and execution, thereby enabling him to better enjoy his excursion.

There are systems designed to assist, in a limited way, in planning a traveler's trip carrying out travel arrangements. For instance, the air transportation industry provides Computerized Reservation Systems (CRS), such as TWA's PARS, that contain information about schedules, fares, rules and availability of seats on flights, with the ability to make reservations. Each CRS is owned or controlled by one or more airlines or airline affiliates and allows direct connection between a travel agent and the internal reservations system of an individual carrier or affiliation. Each travel agency that is connected to a CRS predominantly relies on one system for researching airline service options and making bookings.

With the growth of the travel industry and the need by travel agents, the airlines' primary distribution channel, to compare the schedules and fares offered by different airlines and other travel suppliers and to determine which would best meet their customer's needs, came the Global Distribution Systems (GDS) like Amadous, Galileo, Sabre and Worldspan.

A GDS presents displays that show various services offered in a market, e.g. flights, hotels, cars. tours and cruises, obtaining the available information from and making bookings in the supplier's CRSs. For flights, a GDS shows schedules and fares offered by airlines that are available for sale through travel agents and whether seats are available on specific flights at specific fares.

The agent has the ability to reserve a seat and issue a ticket. Most airlines use paper tickets but these are gradually being replaced by electronic tickets as a means of cutting costs. For other services, a GDS also shows availability and prices as per marketing agreements made between the suppliers and the distribution company. The services shown represent those that are commissionable to travel agents and do not necessarily represent all services offered by all service providers.

In recent years, the Internet has become a major source for information and sale of airline tickets as well as other travel services. Both service providers and travel agencies have created websites where consumers can search for service options and make bookings. The use of the Internet for direct marketing has enabled service providers to offer lower web fares. On-line travel agencies such as Expedia (at http://www.expediu.com), Orbitz (at http://www.orbitz.com), and Travelocity (at http://www.travelocity.com), have become major sellers of airline travel, hotel accommodation, car rental vacations and cruises and sometimes offer many discount fares that are not available for sale through other travel agencies.

On-line agencies also use Global Distribution Systems—Travelocity uses Sabre, while Expedia and Orbitz use Worldspan. Orbitz and Expedia have been developing their own systems that enable reservations to be made directly with an airline's CRS, bypassing Worldspan.

There are systems designed to aid, in a limited way, in the planning and execution of travel arrangements. A number of establishments have provided the public with applications that aided in primarily recreational travel planning through the use of assemblages of multimedia travel information on several recreational locations and activities. Such travel software programs are exemplified by the America NavigaTour™ MediAlive™ multimedia travel guide produced by CD Technology, Inc. and National parks of America, a CD-ROM product of Multicom Publishing. Rand McNally produces a software travel-planning product named TripMaker™, for planning a car trip in the United States, Canada and Mexico. It also calculates quickest or shortest route.

MapQuest provides online mapping and driving directions. Consumers can access color maps of detail in North America or varying detail in many countries, and driving directions to pinpoint locations in North America and Europe or assemble a route, and use MapQuest Find It to find businesses and airports by name or category. Similarly, the American Automobile Association in cooperation with Compton's NewMedia also provides travel planning from a point of origin to a point of destination based on a CD-ROM contained database of travel information that appears to be limited to “suggested routes of travel”, again limiting user choice.

In each case it appears that travel information from multimedia sources is “canned” limiting user's choice. The is no user capability of selecting and constructing a travel plan from a variety of sources accessible with a single search and no provision for the traveler to execute the plan, once developed.

Location-based services (LBS) are services that exploit knowledge about where a wireless device is located.

There are several ways to determine a wireless device's position. Most of them involve using time difference of arrival (TDOA), enhanced observed time difference (E-OTD), and assisted global positioning system (GPS) technologies.

Global Positioning System (GPS) is based on a collection of 24 Navstar satellites that transmit precise navigation messages. There are generally three major components in a GPS solution: the GPS receiver, navigation software and map data. A GPS receiver acquires the transmitted messages and makes them available for processing by navigational software. Almost all the current new GPS receivers are 12-channel parallel receivers that are capable of tracking up to 12 GPS satellites. A receiver only needs 4 satellites to have a 3D fix, or 3 satellites for a 2D fix. Navigation software is capable of real time calculation of a wide array of functions such as determining user position, distance to a destination etc. Map data is an electronic representation of geographical information.

Some attempts have been made to provide tourists with tools for trip planning. U.S. Pat. No. 5,948,040 of DeLorme et al. discloses a computerized travel reservation information and planning system that generates output in various media for guidance and transactions en route. Furthermore, U.S. Pat. No. 5,948,040 discloses an access interface related to routing, topical searching, searches of events calendars, almanacs, appointment books, related itinerary scheduling, trip budgeting, and travel arrangement availabilities. Furthermore, U.S. Pat. No. 5,948,040 discloses a scheduling interface where a user can schedule one or more events of interest for the trip. As disclosed in U.S. Pat. No. 5,948,040, the user and/or a database provides the locations and starting times for each event of interest to be scheduled, and the system indicates of two events of interest pose a scheduling conflict. No system or method for computing a schedule of recreational activities is taught or suggested in U.S. Pat. No. 5,948,040.

LBS systems may use the location-finding capability together with map data to display a user's position on the map and provide directions for his movement to a destination. Some attempts have been made to give travelers direct access to travel service providers. U.S. Pat. No. 5,237,499 issued to Garback describes a planning system that enables a user to develop travel arrangements, through linkage to service providers. However, these arrangements are fixed, based upon pre-set travel destinations, negotiated fares on pre-selected airlines, pre-selected room accommodation providers, and pre-selected ground accommodating providers only. The travel from point A to point B can only be made if those points are city airports. There is no provision for a location where there is no airport and no provision for detailed information related to points of interested at the origin, destination or points along the way.

U.S. Pat. Application No. US 2003/0023463 A1 issued to Dombrosky et al. describes a system for automatically planning, booking and calendaring travel arrangements. However, Dombrosky initiates an automatic creation of a travel request from within a calendar application and the suggested itinerary is based on calendar data and schedule. He connects to a single GDS, and the user is limited to reserving flight(s), hotel(s), rental car(s) and/or rail ticket(s) only. For every type of service, the user must provide a separate profile. No information on points of interest or events of interest is available to the user through Dombrosky's system.

Although not related to the topic of travel or recreational tourism activities, Microsoft Outlook® provides an interface for scheduling personal appointments.

One product that was disclosed by the Sagie Research Ltd is an electronic audio visual touring guide for Personal Digital Assistants entitled “Enarro” (http://www.enarro.com/audiovisualguiding.htm).

### SUMMARY OF THE INVENTION

These and further embodiments will be apparent from the detailed description and examples that follow.

It is now disclosed for the first time a system for generating a travel plan. The presently disclosed system comprises
a) a storage for storing data about a plurality of recreational and/or tourism activities, each respective said recreational and/or tourism activity associated with a respective physical location;
b) an access interface for receiving at least one time interval; and
c) a travel planning engine for generating a travel plan,
   wherein said generating includes computing a schedule of a selected sub-plurality of said recreational and/or tourism activities within said at least one time interval.

According to some embodiments, a plurality of said scheduled recreational and/or tourism activities are each associated with substantially a different physical location.

According to some embodiments, the schedule is computed in accordance with distances between said respective physical locations of said recreational and/or tourism activities.

According to some embodiments, the computing of said schedule includes at least one computation selected from the group consisting of selecting a location of said recreational and/or tourism activity, computing a starting time of said recreational and/or tourism activity, computing a finishing time of said recreational and/or tourism activity, and determining a duration of said at least one recreational and/or tourism activity.

According to some embodiments, the computing of the schedule includes deciding whether or not to schedule a candidate said recreational and/or tourism activity.

According to some embodiments, the computing of said schedule includes effecting a scheduling decision.

According to some embodiments, the starting time of at least one said recreational and/or tourism activity is a free parameter (e.g. the starting time is not a fixed starting time, e.g. not a prescribed time or day), and said computing of said schedule includes determining said starting time.

According to some embodiments, the sub-plurality of recreational and/or tourism activities includes distinct recreational and/or tourism activities.

According to some embodiments, the sub-plurality of recreational and/or tourism activities includes recreational and/or tourism activities from a plurality of recreational and/or tourism activity categories.

According to some embodiments, a time parameter associated with a respective recreational and/or tourism activity is stored in said activity parameter storage.

According to some embodiments, said time parameter is selected from the group consisting of a set of opening hours, a set of one or more starting times, a duration time,

According to some embodiments, said time parameter is a probabilistic time parameter.

According to some embodiments, said time parameter is fixed time parameter.

According to some embodiments, at least one said recreational and/or tourism activity is substantially a localized activity (e.g. at a specific location, including but not limited to a within a radius of, for example, 50 meters, 100 meters, or 300 meters).

According to some embodiments, the substantially localized activity is localized within a specific location within a city.

According to some embodiments, a duration of a scheduled said recreational and/or tourism activity is determined by said travel planning engine in accordance with a duration parameter received through said access interface.

According to some embodiments, said activity parameter storage is operative to store a predicted duration parameter of a said recreational and/or tourism activity.

According to some embodiments, said activity parameter storage is operative to store a probabilistic duration parameter of a said recreational and/or tourism activity.

According to some embodiments, said storage is operative to store personal preference parameters about a user or group of users.

According to some embodiments, said scheduling of said recreational and/or tourism activities includes determining a duration of at least one said recreational and/or tourism activity.

According to some embodiments, said duration of computed in accordance with a personal preference parameter about a user or group of users.

According to some embodiments, said travel planning engine is operative to compute a daily schedule, said daily schedule including a plurality of said selected recreational and/or tourism activities.

According to some embodiments, said travel planning engine is operative to computer said schedule with a granularity of at most three hours.

According to some embodiments, said travel planning engine is operative to computer said schedule with an hourly granularity.

According to some embodiments, said travel planning engine is operative to determine a duration of at least one said recreational and/or tourism activity.

According to some embodiments, the system further comprises an output device for outputting said computed schedule.

According to some embodiments, said output device is scheduled from the group consisting of a hardcopy producing device, a display screen and a non-volatile memory device.

According to some embodiments, access interface is further operative for manual scheduling of at least one selected said recreational and/or tourism activity within said at least one time interval.

According to some embodiments, said access interface provides access to a plurality of scheduling scenarios.

According to some embodiments, said computing of said schedule is in accordance with said manual scheduling of said at least one selected said recreational and/or tourism activity.

According to some embodiments, the system further comprises, a reservation module for reserving a service associated at least one said scheduled activity.

In some embodiments, purchasing is considered a form a “reserving.”

According to some embodiments, said reservation module is an interface for sending directives to a travel services purchasing system external to the scheduling system.

According to some embodiments, said reservation module is a reservations systems.

According to some embodiments, said reservation is a reservation for a said recreational and/or tourism activity.

According to some embodiments, said reservation is selected from the group consisting of a restaurant reservation, an amusement park reservation and a museum reservation.

According to some embodiments, said reservation is a reservation for an supporting resource of at least one said scheduled activity.

According to some embodiments, said reservation is selected from the group consisting of a car rental reservation, a transportation reservation, a flight reservation and a hotel reservation.

According to some embodiments, said reservation engine is operative to update or cancel a said reservation in accordance with changes to said schedule.

According to some embodiments, said travel planning engine includes an activity selection engine and said selection said of sub-plurality is carried out at least in part in accordance with a selection computed by said activity selection engine.

According to some embodiments, said selection is carried out at least in part in accordance with a user preference.

According to some embodiments, said user preference is selected from the group consisting of a user travel goal, user constraint preference and a user travel goal preference.

According to some embodiments, said activity selection engine is operative to select sub-plurality in accordance with a geographic location of at least one said recreational and/or tourism activity.

According to some embodiments, said activity selection engine is operative to select sub-plurality in accordance with a proximity parameter of a first said recreational and/or tourism activity relative to a second said recreational and/or tourism activity.

According to some embodiments, said selection is carried out in accordance with a user profile of a traveling party.

According to some embodiments, said selection is carried out at least in part in accordance with a rating of a said tourism activity.

According to some embodiments, said selection is carried out in accordance with said computed schedule.

According to some embodiments, the scheduling process is thus an iterative process wherein additionally activities are added to and scheduled within a computed schedule.

According to some embodiments, said selection of said sub-preference for a first traveling party is carried out at least in part in accordance with a travel plan of a second said traveling party.

According to some embodiments, a selection of a first said recreational and/or tourism activity is carried out in accordance with a second selected said recreational and/or tourism activity.

According to some embodiments, said selection of said sub-plurality is effected in accordance with an activity category mixture directive.

According to some embodiments, said activity mixture directive is a directive to schedule at least a minimum number or at most a maximum number of said recreational and/or tourism activities from a given activity category.

According to some embodiments, said activity mixture directive is a directive to dedicate at least a minimum or at most a maximum amount of time to recreational and/or tourism activities from a given activity category.

According to some embodiments, said activity mixture directive is a directive to schedule at least or at most a certain of fraction of scheduled time of said recreational and/or tourism activities from a given activity category.

According to some embodiments, said selection of said sub-plurality is carried out in accordance with a history of a traveling party.

According to some embodiments, said history includes properties selected from the group consisting of historical preferences.

According to some embodiments, said selection of said sub-plurality is carried out in accordance with ratings of said recreational and/or tourism activities.

According to some embodiments, said computing of said schedule is carried out in accordance with a history of a traveling party.

According to some embodiments, said history includes properties selected from the group consisting of historical preferences.

According to some embodiments, said computing of said schedule is carried out in accordance with ratings of said recreational and/or tourism activities.

According to some embodiments, said scheduling of said sub-plurality is effected in accordance with an activity category mixture directive.

According to some embodiments, said activity mixture directive is a directive to schedule at least a minimum number or at most a maximum number of said recreational and/or tourism activities from a given activity category.

According to some embodiments, said activity mixture directive is a directive to dedicate at least a minimum or at most a maximum amount of time to recreational and/or tourism activities from a given activity category.

According to some embodiments, said activity mixture directive is a directive to schedule at least or at most a certain of fraction of scheduled time of said recreational and/or tourism activities from a given activity category.

According to some embodiments, said travel planning engine is operative to compute a plurality of said schedules for a plurality of individuals who are together at a time related to at least one said time period. In different examples, two people share a rental car during unscheduled time, share a hotel during unscheduled time, or attend an amusement park together during scheduled time.

According to some embodiments, said plurality of schedules is computed in accordance with competing preferences of respective said individuals.

According to some embodiments, said preferences are selected from the group consisting of budget preferences, activity type preferences, and activity duration preferences.

According to some embodiments, said access interface is operative to receive additional travel planning directives and said schedule is computed in accordance with said received additional travel planning directives.

According to some embodiments, said information about a relationship between constraints and said received additional planning directives is transmitted through said access interface.

According to some embodiments, said constraints are selected from the group consisting of hard constraints, soft constraints and time-periodic constraints.

According to some embodiments, for at least one said activity, said time parameters includes a predetermined start time.

According to some embodiments, said access interface is operative to receive activity user preferences.

According to some embodiments, at least one said activity user preference is a user rating associated with a specific said activity.

According to some embodiments, at least one said activity user preference is a associated with a category of activities, and the system further comprises an activity selector for selecting said activities in accordance with said preferred category of user activities and/or and destination data.

According to some embodiments, said travel planning engine includes a constraint handler, and said travel planning engine is operative to effect an operation selected from the group consisting of said computing of said scheduling and said selection of said sub-plurality in accordance with at least one travel constraint.

According to some embodiments, at least one said constraint is selected from the group consisting of a resources constraint (time, money, frequent flier miles), budget constraint, an absolute requirement constraint, appointments that cannot be changed, availability to the public, a time constraint, a location constraint, a daylight hours constraint, a traffic constraint traffic prediction model; updates on bridge closings, road constructions; online traffic, an availability constraint (activity availability constraint and activity support (e.g. travel, hotel) activity constraint), a dietary constraint, a food spoilage constraint, a estimated crowd constraint, a child friendliness constraint, a safety constraint, a homeland security constraint (e.g. warnings from the State Department), opening hours constraint, a calorie constraint, and a weather constraint.

According to some embodiments, said absolute requirement constraint is a commitment to attend an EOI.

According to some embodiments, said absolute requirement constraint is commitment to visit a POI.

According to some embodiments, said absolute requirement constraint is derived from a ratings database.

According to some embodiments, said absolute requirement constraint is received through said access interface.

According to some embodiments, said budget constraint relates to at least one expenditure selected from the group consisting of an expenditure of a said activity, and an activity support expenditure.

According to some embodiments, said activity support expenditure is elected from the group consisting of an accommodation expenditure, a transportation expenditure (e.g. flight, car rental, gas), and a food expenditure.

According to some embodiments, said constraint is an activity category constraint.

According to some embodiments, said time constraint is selected from the group consisting of an aggregate time constraint and a time interval time constraint.

According to some embodiments, said constraint is selected from the group consisting of a soft constraint and hard constraint.

According to some embodiments, said constraint relates to compatibility in travel needs for a plurality of individual travelers.

According to some embodiments, said constraint is a probabilistic constraint.

According to some embodiments, said access interface is operative to receive information for determining at least in part a said constraint.

According to some embodiments, said scheduling is effected in accordance with activity pricing and/or activity support pricing.

According to some embodiments, said travel planning engine is operative to access a travel commodities cost database (e.g. live feed, searching the web).

According to some embodiments, said planning engine is operative to identify and schedule free activities in order to schedule activities for a subset of said time period.

According to some embodiments, said travel planning engine is operative to handle travel product bundling pricing.

According to some embodiments, said travel planning engine includes a constraint handler, and said travel planning engine is operative to effect an operation selected from the group consisting of said computing of said scheduling and said selection of said sub-plurality in accordance with a value of at least one travel benefit parameter.

According to some embodiments, said travel benefit parameter is selected from the group consisting of a travel convenience parameter, frequent flier miles, a travel cost parameter.

According to some embodiments, said at least one travel benefit parameter is a plurality of competing said travel benefit parameters.

According to some embodiments, said travel benefit parameter is selected from the group consisting of an activity benefit parameter and an activity support benefit parameter.

According to some embodiments, said parameter is a priority parameter of at least one said recreational and/or tourism activity.

According to some embodiments, said scheduling system is distributed at least in part over a computer network.

According to some embodiments, said scheduling system is distributed at least in part over a computer network.

According to some embodiments, said storage device is distributed over a plurality of devices, and the system further comprises a synchronization mechanism operative to synchronize data between said plurality of devices.

According to some embodiments, said storage device is distributed over a plurality of devices, and the system further comprises a synchronization mechanism operative to download data from a first said device to a second said device.

According to some embodiments, said access interface resides on a plurality of networked devices.

According to some embodiments, at least one said networked device is a wireless device.

According to some embodiments, said wireless device includes a location positioning system.

According to some embodiments, said wireless device is selected from the group consisting of a PDA, a cell phone and a personal computer.

According to some embodiments, the system further comprises a mechanism for data synchronization between said plurality of networked devices.

According to some embodiments, the system further comprises a mechanism for downloading data from a first said networked device to a second said networked device.

According to some embodiments, the system further comprises a customer relations management system for providing information about traveler's whose travel plan is generated, said recreational and/or tourism activities scheduled in accordance with said information provided by said customer relations management system.

According to some embodiments, said customer relations management system is operative to provide said information about a plurality of travelers.

According to some embodiments, the system further comprises a mechanism for providing information about an aggregate of a plurality of said travelers.

According to some embodiments said information provided by said customer relations management system is selected from the group consisting of one or more traveler's demographics, preferences, needs, and loyalty programs.

According to some embodiments said travel planning engine is operative to update said schedule in accordance with a plurality of travel feedback parameters.

According to some embodiments, at least one said travel feedback parameter is selected from the group consisting of a detected event, an updated user preference, and a user-effected scheduling of a said recreational and/or tourism activity.

According to some embodiments, said detection of said event includes detecting a location of a mobile device.

According to some embodiments, said updated user preference is received through said access interface.

According to some embodiments, said updated user preference is received from a location tracking device.

According to some embodiments, said travel planning engine is operative to analyze a plurality of scheduling scenarios.

According to some embodiments, said analyzing of said scheduling scenario includes obtaining a value of a parameter associated with a said scheduling scenario.

According to some embodiments, said access interface is operative to effect a manual scheduling of at least one said recreational and/or tourism activity.

According to some embodiments, said travel planning engine is operative to compute said schedule in accordance with said manually scheduled recreational and/or tourism activity.

According to some embodiments, said access interface is further operative to present scheduling suggestions derived from a said computed schedule.

According to some embodiments, the system is operative to schedule said recreational and/or tourism activities iteratively, each said iteration including a said manual scheduling and a said computed scheduling.

According to some embodiments, the system further comprises a data acquisition system for acquiring data related to said recreational and/or tourism activities

According to some embodiments, said data acquisition system is operative to acquire a live feed of said data.

According to some embodiments, said travel planning engine is operative to schedule a said recreational and/or tourism activity in accordance with said live data.

According to some embodiments, the system further comprises an alert system, for alerting a user of updated information related to a said recreational and/or tourism activity.

According to some embodiments, said travel planning engine is operative to schedule a said recreational and/or tourism activity having a non-definite feasibility.

According to some embodiments, said travel engine is operative to compute said schedule in accordance with a geographic location of a said recreational and/or tourism activity.

According to some embodiments, said travel engine is operative to compute said schedule in accordance with a proximity parameter of a first said recreational and/or tourism activity relative to a second said recreational and/or tourism activity.

According to some embodiments, said travel engine is operative to consider coupling effects derived from a presence of a first said recreational and/or tourism activity and a second said recreational and/or tourism activity in the same said computed schedule.

According to some embodiments, said coupling effects is selected from the group consisting of a budget savings enjoyed by purchase of both services related to said first recreational and/or tourism activity and services related to said second recreational and/or tourism activity.

According to some embodiments, said travel plan includes information about traveling along one or more routes between a first said recreational and/or tourism activity and a second said recreational and/or tourism activity.

According to some embodiments, at least one said route is at least in a part a public transportation route, and said information includes public transportation information about traveling along said public transportation route using public transportation.

According to some embodiments, said public transportation information includes at least one of information about transferring between one mode of transportation and another mode of transportation, information about multi-leg train routes, information about multi-leg bus routes, information about navigation within a public transportation terminal, information about navigation within an airport, and information about proximity between a public transportation station and a said recreational and/or tourism activity.

It is now disclosed for the first time a schedule for generating a travel plan comprising:
a) a storage for storing data about a plurality of recreational and/or tourism activities, each respective said recreational and/or tourism activity associated with a respective physical location;
b) an access interface for receiving at least one time interval; and
c) a travel planning engine for generating a travel plan,
   wherein said generating includes making a schedule of a selected sub-plurality of said recreational and/or tourism activities within said at least one time interval, wherein said travel plan includes public transportations directions from one said recreational and/or tourism activity to another said recreational and/or tourism activity.

According to some embodiments, at least one said route is at least in a part a public transportation route, and said information includes public transportation information about traveling along said public transportation route using public transportation.

According to some embodiments, said public transportation information includes at least one of information about transferring between one mode of transportation and another mode of transportation, information about multi-leg train routes, information about multi-leg bus routes, information about navigation within a public transportation terminal, information about navigation within an airport, and information about proximity between a public transportation station and a said recreational and/or tourism activity.

It is now disclosed for the first time a method of generating a travel plan, the method comprising:
a) receiving data about a plurality of recreational and/or tourism activities, each respective said recreational and/or tourism activity associated with a respective physical location;
b) receiving at least one time interval; and
c) generating the travel plan, wherein said generating includes computing a schedule of a selected sub-plurality of said recreational and/or tourism activities within said at least one time interval.

According to some embodiments, said data is stored in a storage, said storage comprising at least one of volatile memory and non-volatile memory.

It is now disclosed for the first time a computer readable storage medium having computer readable code embodied in said computer readable storage medium, said computer readable code for generating a travel plan, said computer readable code comprising instructions for:
a) receiving data about a plurality of recreational and/or tourism activities, each respective said recreational and/or tourism activity associated with a respective physical location;
b) receiving at least one time interval; and
c) generating the travel plan, wherein said generating includes computing a schedule of a selected sub-plurality of said recreational and/or tourism activities within said at least one time interval.

It is now disclosed for the first time method of scheduling a plurality of recreational and/or tourism activities, the method comprising:
a) graphically displaying geographical location information about a plurality of recreational and/or tourism activities through a user interface, each said recreational and/or tourism activity associated with a respective displayed geographical location;
b) receiving through said user interface location identifications of a plurality of said displayed geographical locations, each said identification operative to specify a respective associated said recreational and/or tourism activity;
c) scheduling within a given time period at least some said specified recreational and/or tourism activities.

According to some embodiments, said displaying includes displaying location information on a map, and at least one said identification is an identification of a said geographical location on said displayed map.

According to some embodiments, said user interface is operative to display feasibility information about at least one said recreational and/or tourism activity.

According to some embodiments, said feasibility information is derived in accordance with said scheduled recreational and/or tourism activities. One example of feasibility information is a temporal conflict. Another example is a geographic location conflict, e.g. a meeting cannot be scheduled at 9 AM in San Diego and another meeting at 10 AM in Boston.

According to some embodiments, a granularity of said displayed geographical location is a sub-metropolitan granularity.

It is now disclosed for the first time computer readable storage medium having computer readable code embodied in said computer readable storage medium, said computer readable code for scheduling a plurality of recreational and/or tourism activities, said computer readable code comprising instructions for:
a) graphically displaying geographical location information about a plurality of recreational and/or tourism activities through a user interface, each said recreational and/or tourism activity associated with a respective displayed geographical location;
b) receiving through said user interface location identifications of a plurality of said displayed geographical locations, each said identification operative to specify a respective associated said recreational and/or tourism activity;
c) scheduling within a given time period at least some said specified recreational and/or tourism activities.

It is now disclosed for the first time a method of scheduling a plurality of travel activities, the method comprising:
a) receiving activity preferences, location constraints, budget constraints and at least one time period from a user;
b) presenting a plurality of recreational and/or tourism activities satisfying said received activities preferences, said location constraints and said budget constraints;
c) receiving a selected subset of said presented activities;
d) scheduling said selected subset of said activities within said at least one time period.

According to some embodiments, said budget constraints are selected from the group consisting of an activity-specific budget constraints, aggregate budget constraints, and an activity category budget constraint.

According to some embodiments, only recreational and/or tourism activities satisfying said received activities preferences, said location constraints and said budget constraints.

It is now disclosed for the first time a system for trip planning comprising:
a) an activity topic selection interface for selecting an recreational and/or tourism activity category from a plurality of recreational and/or tourism activity category;
b) an activity display interface from displaying description data describing at least one recreational and/or tourism activity associated with said selected recreational and/or tourism activity category;
c) a recreational and/or tourism activity selection input for selecting at least one said displayed activity;
d) a selected activity display for displaying said selected activities.

According to some embodiments, system further comprising:
e) a location selection interface for selecting a location from a plurality of locations, wherein said activity display interface is operative to display description data associated with said selected recreational and/or tourism activity category in said selected location.

According to some embodiments, said description data includes at least one of graphical description data, an image of a person engaging in a said recreational and/or tourism activity, a video of said recreational and/or tourism activity, a textual description of said recreational and/or tourism activity, a photo-album and a textual description of said recreational and/or tourism activity, pricing information, duration or estimated duration information, location information, and rating information.

According to some embodiments, said activity category selection interface is operative for selection of subcategories of said categories, and said activity displayed interface is operative to display recreational and/or tourism activity associated with said selected subcategory.

According to some embodiments, said activity category selection interface includes a tree interface for selecting said sub-categories.

According to some embodiments, the system further comprises a sorting mechanism for sorting said displayed recreational and/or tourism activities by location.

According to some embodiments, the system further comprises an activity display populator for computing a selection of at least one said recreational and/or tourism activity, and said activity display is operative to display said at least one computed recreational and/or tourism activity.

It is now disclosed for the first time a system for trip planning comprising: a personal details database for storing customer data including at least one of customer preferences (e.g. airliners, airline window seats), and customer needs (e.g. wheelchair, religious dietary needs) and customer demographic data (e.g. name, age, gender) for at least one customer; an access interface for receiving at least one time period (e.g. a time period or a plurality of time blocks) and at least one location; a scheduler for scheduling a plurality of activities during said at least one time period in accordance with said at least location and at least one of said customer preferences, customer needs and customer demographic data.

It is noted that the CRM and travel plan generation system can be implemented in some embodiments as two separate modules, or alternatively as a single module with dual functionality.

According to some embodiments, the travel agent system supports price markup differentials. In one example, the travel vendor pays a commission to the agent and the agents has the opportunity to reduce his commission and pass on the savings the client.

According to some embodiments, said personal details database further includes at least one of credit and price differentials and said scheduler is operative to effective said scheduling in accordance with at least one of said credit and price differentials.

According to some embodiments, said scheduler includes one of a scheduling computation system for computing said scheduling and a scheduling access interface for receiving user scheduling directives.

It is now disclosed for the first time a method of presenting information about pricing of at least three targeted travel services, each respective travel service from a different travel category, the method comprising:
a) providing a vendor identifier for each respective travel service;
b) receiving a travel departure location, a travel destination location and an approximate travel time from a user;
c) after said receiving of said travel departure location and said travel destination location, presenting to said user a single screen including a plurality of distinct bundling combinations, at least one said bundling combination including at least one bundling of a plurality of travel services, each said bundling combination operative to supply all of the target travel services.

According to some embodiments, said single screen is operative to display said bundling combination in accordance with loyalty program information.

According to some embodiments, said single screen includes pricing information about said presented bundling combinations.

According to some embodiments, said single screen is operative to display said pricing information in accordance with loyalty program information.

According to some embodiments, said single screen includes information about pricing savings associated with one said bundling combination with respect with another said bundling combination.

It is now disclosed for the first time a method of providing travel information to a user, the method comprising:
a) receiving a travel departure location, a travel destination location and an approximate travel time from a user;
b) presenting information about a plurality of travel options from said source to said destination, wherein a first said travel option includes a first mode of transportation between said travel departure location and a travel destination location, and a second travel option includes a second mode of transportation different from said first mode between said travel departure location and a travel destination location.

It is now disclosed for the first time a method of effecting a price comparison of travel options, the method comprising:
a) receiving a travel departure location, a travel destination location and an approximate travel time from a user;
b) obtaining information about a plurality of travel options from said source to said destination, each travel option associated with a respective price, wherein a first said travel option includes a first mode of transportation between said travel departure location and a travel destination location, and a second travel option includes a second mode of transportation different from said first mode between said travel departure location and a travel destination location,
c) effecting a comparison of said respective prices.

According to some embodiments, the method further comprises presenting information about a cheapest said travel option.

According to some embodiments, said pricing information is in accordance with membership with a travel club.

It is now disclosed for the first time a method for querying recreation activities, the method comprising:
a) receiving only once identifiers of a plurality of destinations;
b) presenting a single screen including a plurality of recreational and/or tourism activities, each said recreational and/or tourism activity associated with a respective location among said received destinations, said recreational and/or tourism activities segregated according to their respective locations.

According to some embodiments, said segregation is effected by a toggling mechanism operative to display said recreational and/or tourism activities associated with a single activated said destination.

It is now disclosed for the first time a system for displaying information about a plurality of travel legs of a multi-leg journey, the system comprising:
a) an location interface for specifying at least three locations associated with a multi-leg journey having at least two travel legs between said specified at least three locations;
b) a single leg display interface for displaying information about a single said travel leg; and
c) a selection mechanism for selecting one said travel leg from said at least two travel legs,
wherein said single leg display interface is operative to display information about said selected travel leg.

According to some embodiments, said single leg display interface is operative to display information about only said selected travel leg.

It is now disclosed for the first time a scheduling system comprising:
a) a storage for storing data about a plurality of recreational and/or tourism activities, each respective said recreational and/or tourism activity associated with a respective physical location;
b) an access interface for receiving at least one time interval;
c) a scheduling interface for scheduling of a selected sub-plurality of said recreational and/or tourism activities within said at least one time interval, said scheduling window operative for scheduling a plurality of scheduling scenarios; and
d) a toggling mechanism for toggling between said scenarios.

According to some embodiments, said scheduling interface includes a scheduling window operative to display a plurality of time blocks.

It is now disclosed for the first time a system for customizing a travel itinerary for a traveler, comprising: means for sending and receiving data from a plurality of databases; means for selecting points of interest and prioritizing points of interest and means for making reservations; means for selecting events of interest and means for making reservations wherein scheduling and selection of the points of interest and, optionally, events of interest provides the traveler with a trip organization that maximizes efficiency and ease of travel; means for determining cost of travel itinerary; means for controlling costs of the travel itinerary based upon the traveler's budget; means for transmitting the travel itinerary for use by the traveler; and means for managing customer relations.
According to some embodiments, the data received from databases comprises distance information between points of interest and events of interest and travel times.

According to some embodiments, the data received from the databases comprises one or more or plane, train, auto, ferry reservation data.

According to some embodiments, the means for selecting points of interest and means for making reservations use data regarding travel time limits and traveler budget limits and wherein the means for selecting points of interest arranges the itinerary to schedule travel to and from points of interest in the most efficient and cost effective arrangement possible.

According to some embodiments, means for selecting events of interest and means for making reservations use data regarding travel time limits and traveler budget limits and wherein the means for selecting points of interest arranges the itinerary to schedule travel to and from points of interest in the most efficient and cost effective arrangement possible.

According to some embodiments, the means for selecting events of interest provides event options to the traveler that the traveler did not initially specify.

According to some embodiments, the system further comprises a list of points of interest and events of interest wherein specific points and events are selectable by the traveler or travel agent.

According to some embodiments, the system further comprises a pictorial view of an event or a point of interest.

According to some embodiments, the means for sending and receiving data from a plurality of databases comprises at least one server.

According to some embodiments, the means for maximizing efficiency and ease of travel includes providing information in the travel itinerary concerning location of parking lots nears events of interest.

According to some embodiments, the itinerary includes specific directions for traveling from one point of interest to another.

According to some embodiments, the system further comprises a docking station for docking a hand held device.

According to some embodiments, the system further comprises a hand held device for receiving information concerning the travel itinerary.

According to some embodiments, the hand held device is updated during travel to reflect changes in the travel itinerary.

According to some embodiments, the travel itinerary is arranged sequentially with respect to time on the hand held device.

According to some embodiments, the system further comprises a graphical user interface displaying a time line showing places of interest and farther illustrates money spent as a fraction of the travel budget.

According to some embodiments, the graphical user interface is transmitted to the traveler's hand held device so that the traveler monitors money spent versus money budgeted during the course of the trip.

According to some embodiments, the data transmitted to the hand held device is encrypted.

According to some embodiments, the data transmitted to the hand held device comprises emergency contact information for the traveler.

According to some embodiments, the data transmitted to the hand held device comprises visual images of points of interests.

According to some embodiments, the means for managing customer relations comprises providing the itinerary in the traveler's native language.

According to some embodiments, the means for managing customer relations comprises providing contact information so that the traveler may obtain general or specific information and assistance quickly while traveling.

According to some embodiments, the hand held device is received from a particular location and is returned to a particular location.

According to some embodiments, the hand held device is provided by the traveler.

It is now disclosed for the first time a method for customizing a travel itinerary for a traveler, comprising:
selecting events of interest and means for making reservations wherein scheduling and selection of the points of interest and, optionally, events of interest provides the traveler with a trip organization that maximizes efficiency and ease of travel; determining cost of travel itinerary; controlling costs of the travel itinerary based upon the traveler's budget;
transmitting the travel itinerary for use by the traveler; and managing customer relations.

It is now disclosed for the first time an electronic travel itinerary, comprising:

a graphical user interface that include a time line showing places of interest for each day of the itinerary, total budget, and remaining budget each day of the itinerary.

According to some embodiments, the itinerary further comprises a list of events of interest at each place of interest for each day of the itinerary.

According to some embodiments, the itinerary further comprises images of places of interest and points of interest.

According to some embodiments, the itinerary further comprises means for contacting others for additional information or to report an emergency situation or both.

It is now disclosed for the first time a hand held device comprising the presently disclosed electronic travel itinerary.

It is now disclosed for the first time an automated process for preparing a detailed, customized itinerary for a traveler, comprising:
generating a route of travel between origin and destination, including waypoints along the way, based upon query results and a consideration of scheduling factors, appointments that cannot be changed, priority, geographical location, proximity and availability to the public.

According to some embodiments, the system is adaptable to any language.

According to some embodiments, the system further comprises voice recognition and voice connect capability.

### BRIEF DESCRIPTION OF THE DRAWINGS

FIG. 10 is a block diagram describing a travel management system according to some embodiments of the present invention.

FIG. 15 is a block diagram describing a travel planning system according to some embodiments of the present invention.

FIG. 17 is a block diagram of external information accessed by a travel management system according to some embodiments of the present invention

FIG. 20 provides an image of an exemplary interface for inputting travel destinations.

FIG. 30 provides an image of an exemplary interface for selecting candidate recreational and/or tourism activities.

FIG. 40 provides an image of an exemplary interface for scheduling recreational and/or tourism activities.

FIG. 50 provides an image of an exemplary contact information interface.

FIG. 60 provides an image of an exemplary monthly view interface.

FIG. 70 provides an image of an exemplary daily view interface.

FIG. 80 provides an image of an exemplary map view interface.

FIG. 90-100 provide images of an exemplary multi-leg transportation information interface.

FIG. 110 provides an image of an exemplary bundling combination presentation interface.

FIGS. 120-200 provide images of an exemplary itinerary preparation process.

FIG. 210 provides an image of exemplary travel plan residing on a person digital assistance.

### DETAILED DESCRIPTION OF THE INVENTION

The present invention will now be described in terms of specific, example embodiments. It is to be understood that the invention is not limited to the example embodiments disclosed. It should also be understood that not every feature of the methods, apparatus and computer readable code for managing travel described is necessary to implement the invention as claimed in any particular one of the appended claims. Various elements and features of devices are described to fully enable the invention. It should also be understood that throughout this disclosure, where a process or method is shown or described, the steps of the method may be performed in any order or simultaneously, unless it is clear from the context that one step depends on another being performed first.

As used herein, “computing a schedule” of a plurality of recreational and/or tourism activity includes at least one of determining a starting time of a recreational and/or tourism activity, determining an ending time of a recreational and/or tourism activity, determining a duration of a recreational and/or tourism activity, determining a location of a recreational and/or tourism activity, and determining whether or not a recreational and/or tourism activity is to be added to a schedule. It is noted that the scheduling decisions (e.g. the aforementioned scheduling decisions) in the context of “computing a schedule” or effected by a computational procedure. This is in contrast to systems wherein events or visits to points of interest with a predetermined schedule (e.g. pre-bundled travel products, for example, a bundling between flights, hotel, museum tickets and tickets to an amusement park) are presented or provided to a user. Embodiments of the present invention providing “computing a schedule” are in contrast to systems where a user schedules recreational and/or tourism activities through an access interface. Optionally, computing a schedule of a plurality of recreational and/or tourism activities includes selecting one or more recreational and/or tourism activities to be scheduled from a plurality of recreational and/or tourism activities. According to some embodiments, a system operative to “compute a schedule” is thus endowed with decision-making capability.

According to some embodiments, “recreational activities” or “tourism activities” are defined as activities where a person or group of people goes somewhere to do something recreational or related to tourism for a certain period of time. Examples of tourist activities include visits to specific “points of interests” such as museums, historical landmarks, shops, spas, health clubs, amusement parks, etc. Activities also include events of interest, such as concerts, sporting events, films, etc. Each recreational activity is conducted in substantially a single geographic location, as opposed to travel (e.g. flights, train tickets, etc) from one location to another location, which is not to be considered as recreational or tourisms activities. Thus, travel arrangements, accommodations arrangements (e.g. lodging arrangements) and rental car arrangements are not considered recreational activities per se, but rather as “activity support resources” enabling people to reach and/or remain at specific geographic locations in proximity of desired points of interest or events of interest.

It is noted that at a minimum, a “travel plan” includes a schedule of recreational and/or tourism activities along with location information about the recreational and/or tourism activities and information about traveling between the recreational and/or tourism activities (e.g. road directions, walking directions, public transportation directions).

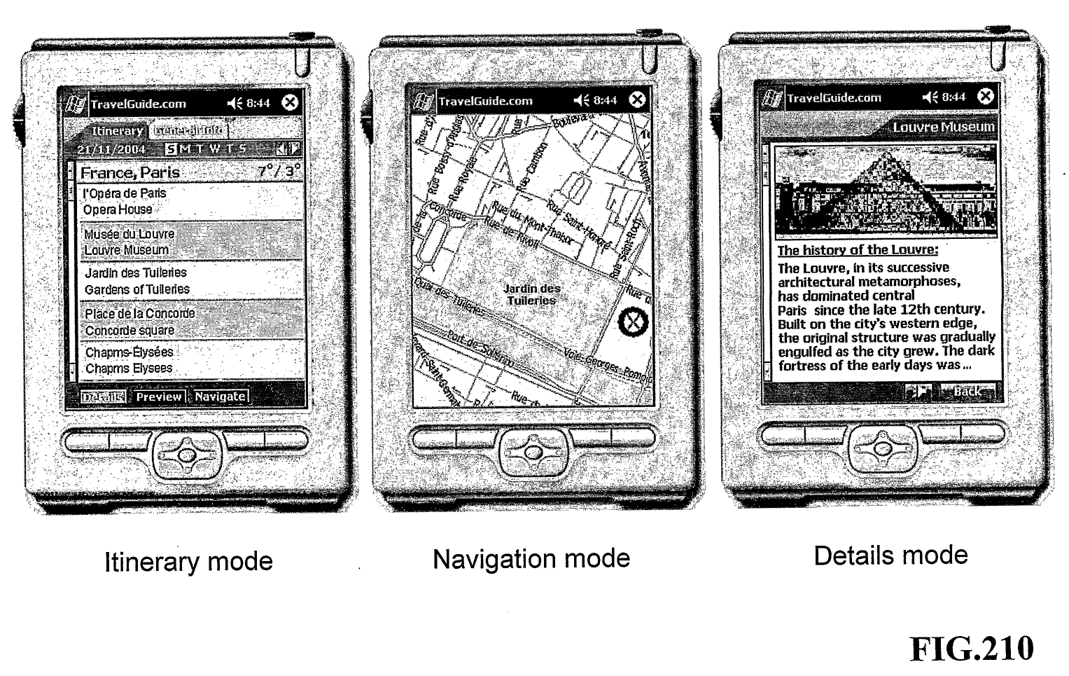

Optionally, the travel plan resides on a portable electronic device as illustrated in FIG. 210. Optionally, the travel plan is a dynamic travel plan which updates in accordance with detected or reported events that occur during a time of execution of the travel plan.

Optionally, the travel plan includes at least one of information about the recreational and/or tourism activities (see “Details mode” of FIG. 210 providing a history of the Louvre, where visiting the Louvre is the recreational and/or tourism activity) and/or information about activity support resources. Thus, in one example where a person is scheduled to fly to Paris and engage in certain recreational and/or tourism activities, the travel plan includes information about travel support resources (e.g. a destination airport, which is not a site of a recreational activity per se). In some embodiments, the travel plan optionally includes information about traveling between a location of a travel support resource (e.g. hotel) and another travel support resource (e.g. bus stations), and/or information about a travel between a travel support resource (e.g. an airport) and a location of a recreational and/or tourism activity.

Thus, in particular embodiments, particularly certain embodiments where the travel plan resides on a portable electronic device, the user of the generated travel plan can take the electronic device with him throughout the trip and receive appropriate travel information in accordance with the travel plan at any given moment. It is noted that in some embodiments, this information is not limited to information directly related to the tourism and/or recreational activities but also includes auxiliary services (e.g. travel support services).

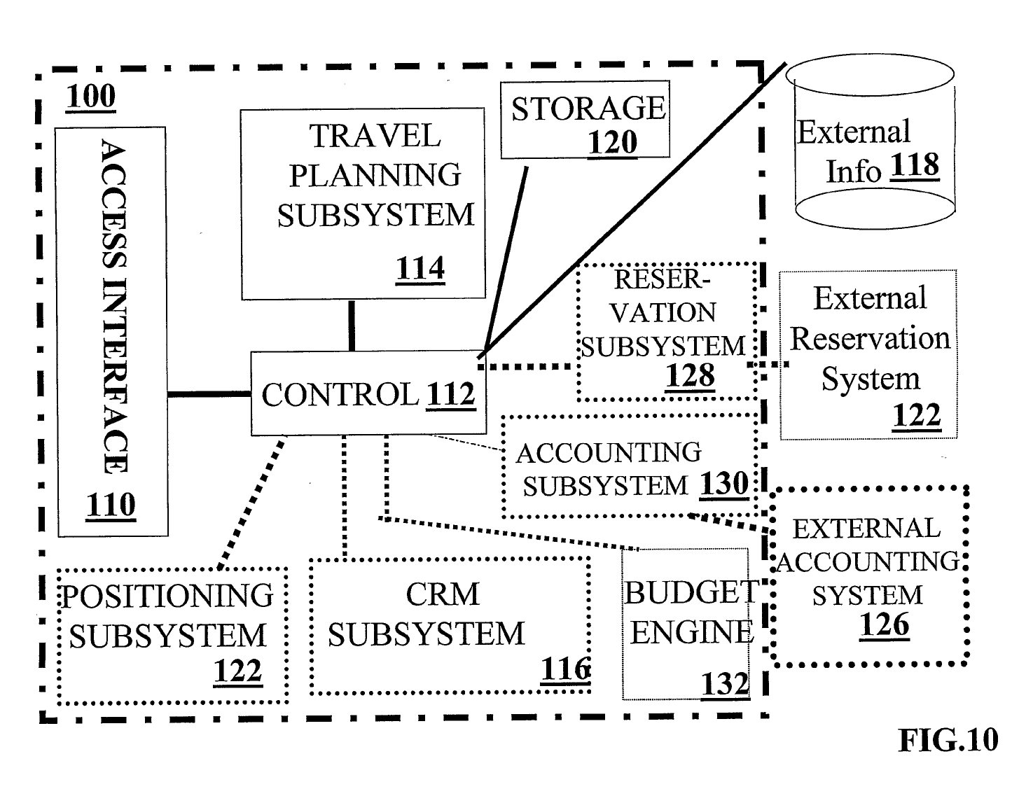

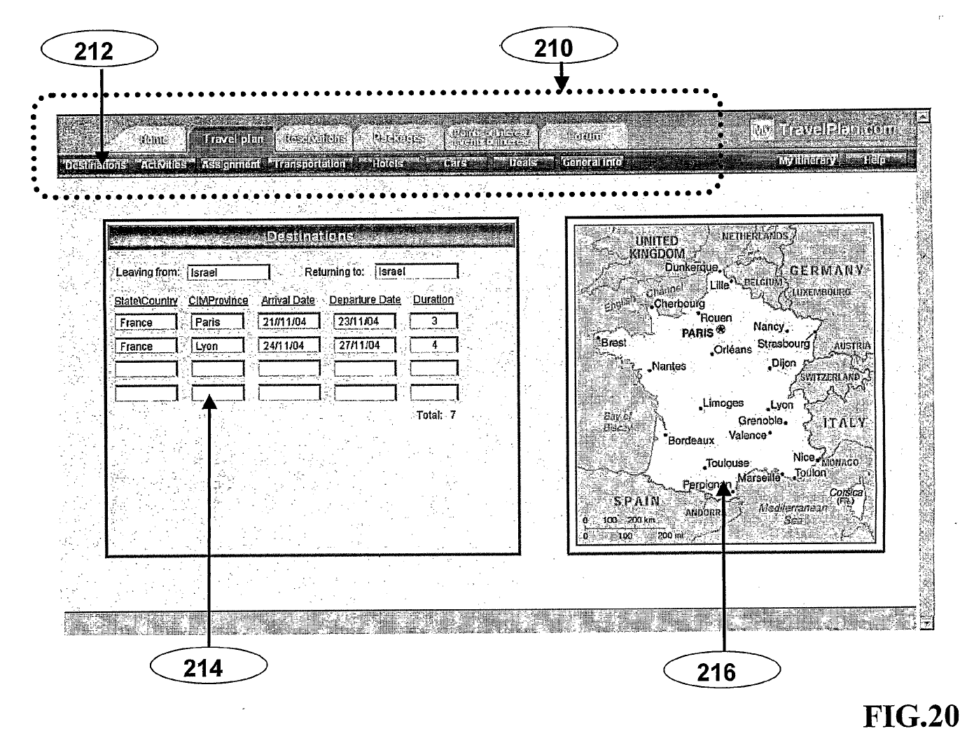

FIG. 10 provides a block diagram of an exemplary electronic travel system 100 in accordance with some embodiments of the present invention. It is noted that the presently described electronic travel system and any of the components described in FIG. 20 may be implemented using any appropriate combination of hardware and/or software.

The access interface 110 receives travel time information such as at least one time interval as well as destination interface from a user. In some embodiments, the at least one time interval is one or more time blocks. As used herein, a “user” is any party using a computerized system for managing travel and/or engagement in tourism and/or recreational activities. Exemplary users include but are not limited to an individual traveler or groups of travelers, a travel agent, and a party associated with a corporate travel department.

It is noted that the access interface 110 as well as any other component described herein may be provided within a single electronic device or may be distributed throughout a plurality of networked electronic devices. Appropriate electronic devices include but are not limited to microcomputers, servers, mainframes, and portable electronic devices including but not limited to personal digital assistants including but not limited to Blackberry® devices, Palm® devices, PocketPC® devices, and mobile telephones. Optionally, the travel system 100 includes a positioning subsystem 122. In one example, the positioning subsystem 122 is useful, for sending information about the actual position of one or more travelers. According to this example, if a traveler is unexpectedly detained in traffic, the scheduling engine 140 of the travel planning subsystem 114 is operative to update the schedule in accordance with the new reality presented by the traveler's being detained.

As shown in FIG. 10, the system includes an optional accounting subsystem 130 (either internal and/or operative to communicate through an appropriate interface with an external accounting system 126), an optional reservation subsystem 128 (either internal and/or operative to communicate through an appropriate interface with an external reservation system 122), an optional budget engine 132 and an optional CRM subsystem 116.

According to some embodiments, each electronic device provides electronic storage 120 (e.g. volatile and/or non-volatile memory) for storing relevant data. Optionally, a mechanism for downloading and/or synchronizing data between one or more electronic devices of the electronic travel system 100 is provided.

The difference between synchronization and downloading will be explained according to a specific example. According to this specific example, Device X contains data “A,B,C,D” and device Y contains data “A,C,E” before synchronization and/or download. Downloading data from device X to device Y is operative to replace the data in device Y with data in device X, thereby yielding a state wherein both device X and Y contain the identical data “A,B,C,D.” Downloading data from device Y to device X is operative to replace the data in device X with data in device Y, thereby yielding a state wherein both device X and Y contain the identical data “A,C,E.” After a data synchronization is performed, each device contains the maximal common set of data, namely, “A,B,C,D, and E.”

Although the previous paragraph noted that the access interface 110 may optionally be distributed among a plurality of networked devices, it is noted that any element described in FIG. 10 may optionally be distributed among a plurality of networked devices.

There is no explicit limitation on the “control” 112 appearing in FIG. 10. Any implementation of the control operative such that the elements of FIG. 10 appropriately communicate and/or work together is appropriate for the present invention. In some embodiments, there is no explicit “control” 112 because the other constitutive elements of FIG. 10 are configured to work together without the need for an explicit control (e.g. the “control” is implicit and distributed among the elements). It is noted that the optional control 112, as well as any element of FIG. 10, can be implemented in software, hardware or any combination thereof.

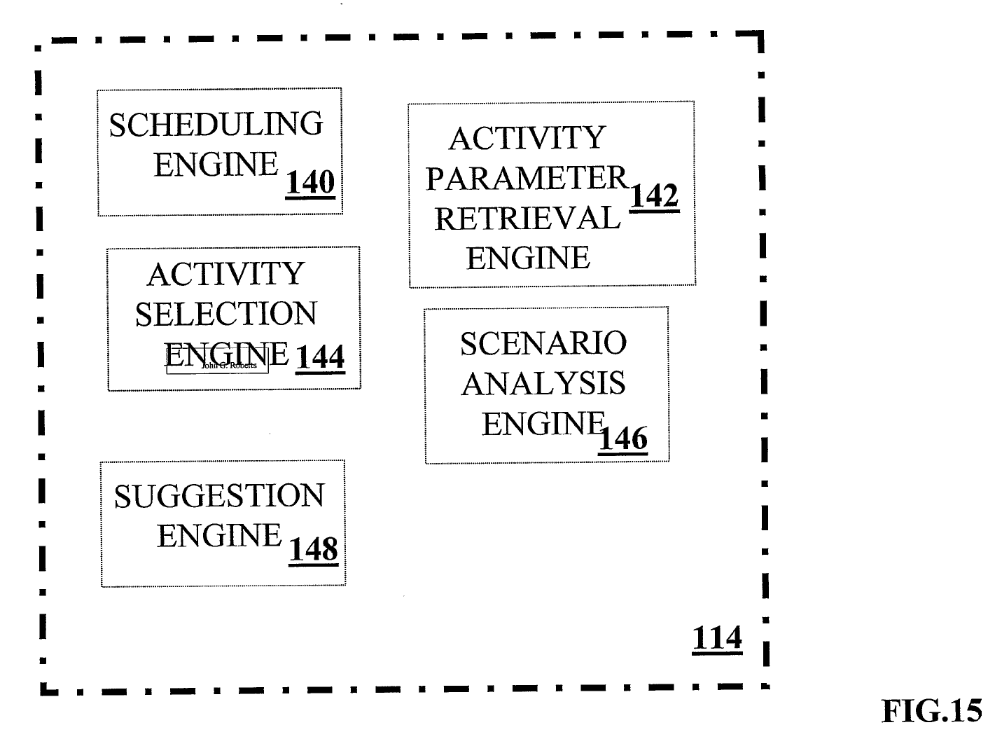

It is noted that in exemplary embodiments, the travel planning subsystem 114 includes any combination of the one or more optional components shown in FIG. 15. These travel planning subsystem 114 components include a scheduling engine 140 for deriving a schedule of a plurality of activities, an activity retrieval parameter engine 142 for retrieving activity data from one or more external information sources 118, and activity selection engine 144 for selecting one or more recreational and/or tourism activities to be scheduled, a suggestion engine 148 for providing activity and/or scheduling and/or activity support suggestions, and a scenario analysis engine 146 for analyzing activity and/or scheduling scenarios.

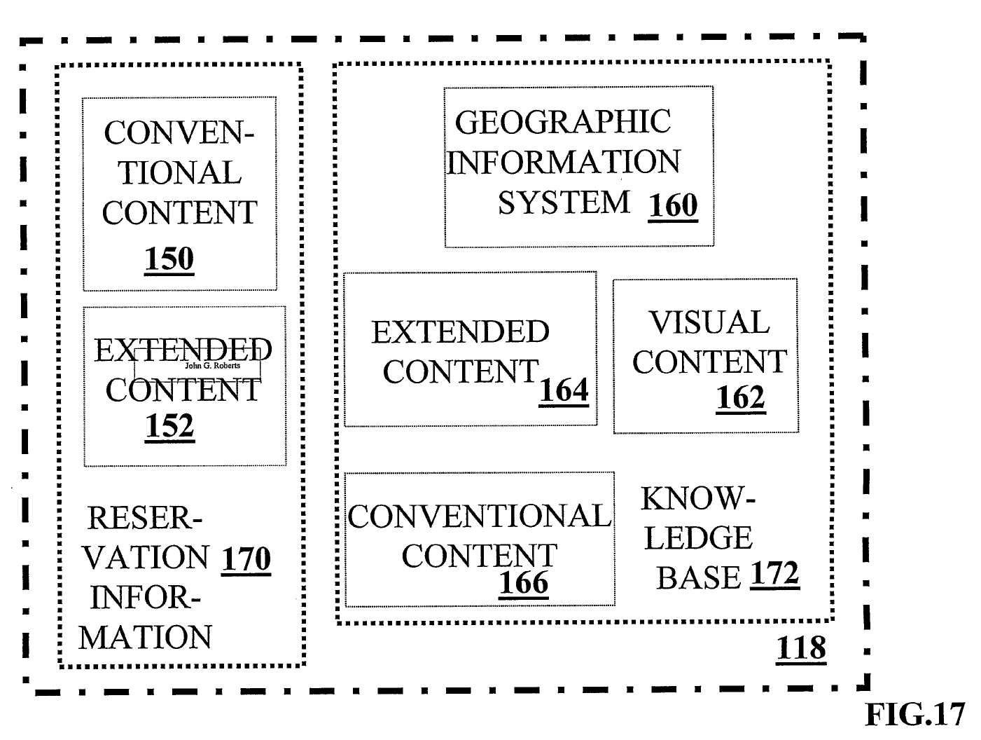

It is noted that the present invention imposes no specific limitation on the content provided by the external information sources 118. Referring to FIG. 17, it is noted that the external information sources 118 optionally include reservation information 170 and/or optional knowledge base 172 content. Exemplary knowledge based travel content 172 may include at least one of conventional content 166 (available, for example, from Michelin™ and Lonley Planet™), extended content 164 (available, for example, from Franchize™), geographic information system content 160 (available, for example from AutoRoute™ and MapQuest™) and visual content 162 (such as maps or images or videos of relevant recreational and/or tourism destinations). Optionally, the extended content 164 includes time relevant content such as updated content. One example of updated content is the presence of a specific art exhibition at a museum, a scheduled concert, etc. According to some embodiments, the content includes reservation information content 170. The reservation information 170 content may be extended content 152 obtainable from any appropriate source such as from the Worldspan™ or Galileo® reservation systems, or conventional content 150 available from internet sites providing reservation information (e.g. Easyjet™, RayanAir™).

There is no limitation on the storage 120 depicted in FIG. 10. The storage 120 may include any combination of volatile and/or non-volatile memory. In some embodiments, the storage includes only volatile memory. Alternatively or additionally, the storage 120 includes an internal database.

There is no limitation on how the storage 120 is populated with activity parameter data. FIGS. 20-30 describe an exemplary scenario wherein activity parameter data relating to a specific location and time period is obtained. FIG. 20 provides an interface whereby at least one destination and optionally time parameters are specified in a destination window 214. As shown in FIG. 20, the active destinations are Paris, France and Lyon, France. The interface of FIG. 20 includes a map window 216 for displaying the destinations on the map and a plurality of tabs 210 for selecting an active interface screen. As shown in FIG. 20, the “Destinations” tab 212 was selected.

As shown in the Figures, the destinations do not need to be selected a plurality of times. Thus, after the destinations are entered into the interface of FIG. 20, the system is “aware” of the user destinations, and there is no need to enter them in later menus, e.g. interfaces operative to schedule recreational and/or tourism activities, interfaces for making reservations, etc. Nevertheless, it is noted that this feature where destinations are received by the system only once is by no means a limitation of the present invention.

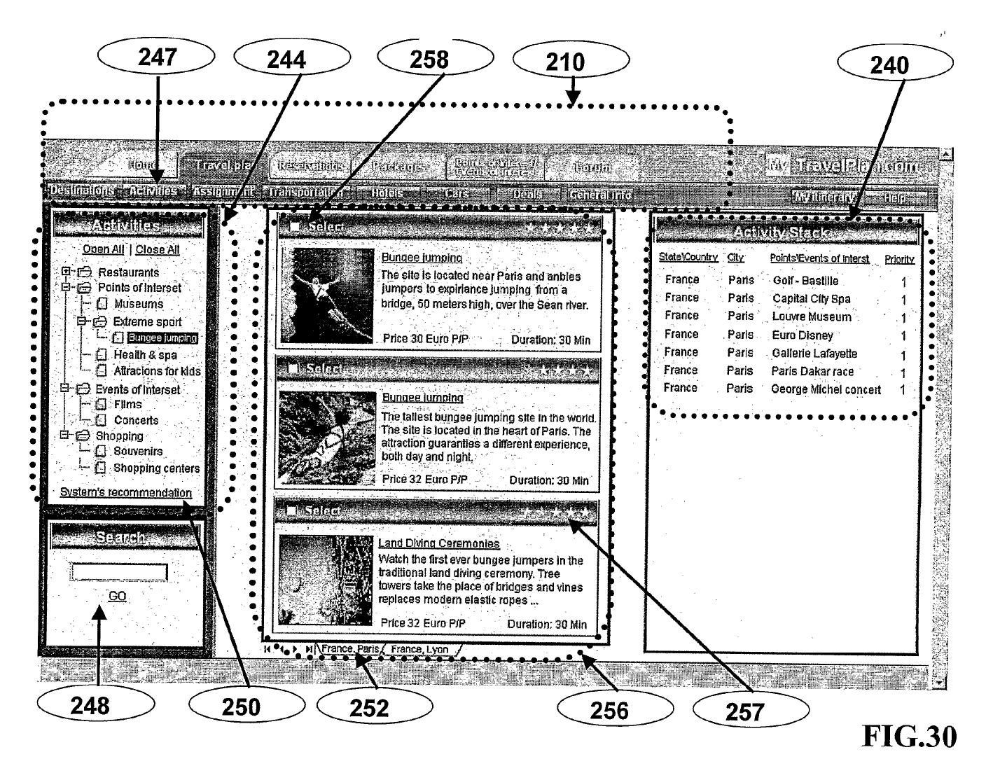

Referring now to FIG. 30, the exemplary user interface includes a window for specifying and/or selecting activity categories 244, a candidate activities window 256 displaying information about potential activities, and an activity stack 240 which displays information related to specific activities selected by the user as possible activities to be scheduled. This activity selection user interface is activated with the “activities” tab 247. The activity category 244 window contains a menu with general activity categories as well as more specific sub-categories. The general categories visible in the activity category window 244 of FIG. 30 are “restaurants,” “points of interest”, “events of interest”, and “shopping.” The category of “Points of interest” has subcategories “Museums,” “Extreme Sport,” “Health & spa,” and “Attractions for Kids.” Within the subcategory “Extreme sport” is the activity type “Bungee jumping.” The categories and subcategories are represented using an expandable tree.

The user can specify a category and/or subcategory, or alternatively the user specifies one or more search terms entered through the search window 248, and the activity parameter retrieval engine 142 then retrieves appropriate data about parameters related to the selected category or subcategory. This information may be retrieved from external sources 318 or alternatively from within the electronic travel system 100.

For the example of FIG. 30, the activity type “bungee jumping” was selected for the locale of Paris, which was selected as a destination in FIG. 20. It is noted that the interface of FIG. 30 provides a mechanism 252 for toggling between selected destination, and the activities displayed in the candidate activities window 256 are associated with the selected destination. For the particular example of FIG. 30, for each activity descriptive data is provided, such as a descriptive image, a price, descriptive text, a rating 257 (in this case 1-5 stars), and an estimated duration.

In some embodiments, candidate activities retrieved into the candidate activities window 256 in accordance with a selected category or sub-category selected in the activity category window 244. Alternatively or additionally, candidate activities are retrieved according to a search query 248. Alternatively or additionally, candidate activities are recommended by the system by activating the “System's recommendation” 250 link.

There is no explicit limitation on the types of activities that can be recommended by the travel planning engine 114. In some embodiments, the “System's recommendations” are provided according to the explicit or implicit user ratings of various points or events of interest in a specific geographical location. In one example, a user visiting Paris wants a list of “must see” attractions. According this example, the city could recommend attractions like the Louvre, the Arche De Triumph, and Euro Disney. This “System's recommendation” feature saves the user the labor intensive process of seeking out specific attractions one by one on the internet or in printed guides.

Alternatively or additionally, the “System's recommendation” are provided in accordance with user supplied preferences or priorities. According to a specific examples, a user indicates that he or she wants to visit shopping centers, and the “System's recommendation” is a list of one or more shopping centers. In one example, a user indicates a preference for Chinese food, and the system provides a Chinese restaurants that have received high ratings.

In some embodiments, the user provides a limitation on the types of recreational or tourism activities for which he wants a recommendation. In one example, wants up to three recommended shopping malls, and the limitation is a maximum number. Alternatively or additionally, the limitation is a specific that a certain fraction of suggested activities will be from a specific recreational or tourism activity category. In one specific example, a user specifies that 20% of the “System's recommendations” tourism or recreational activities be museums.

In one example, the activities are recommended according to historical user data. For example, if a traveler during a first trip went skiing, this could indicate a proclivity for extreme sports, and on a trip to a tropical destination, other extreme sports such as rock climbing or water skiing could be recommended. Systems for recommending goods or services based on historical user taste are well known in the hard, for example, Launchcast® from Yahoo®.

Referring again to FIG. 30, interface is operative to allow a user to select certain candidate activities from the candidate activities window 256 and to populate an “activity stack” 240 with the user-selected candidate activities. There is no explicit limitation on how the interface allows the user to select activities to populate the activity stack. For example, the “select button” 257 may be used, or an icon may be dragged and dropped to the area of the “activity stack” 240.

It is now disclosed for the first time a system for trip planning. The system includes an activity topic selection interface for selecting an recreational or tourism activity category from a plurality of recreational or tourism activity categories, an activity display interface from displaying description data describing at least one recreational activity associated with the selected recreational activity category, a recreational or tourism activity selection input for selecting at least one displayed activity, and a selected activity display for displaying said selected recreational or tourism activities.

It is noted that FIG. 30 describes one exemplary embodiment of this presently disclosed system for trip planning. As illustrated in FIG. 30, the window for specifying and/or selecting activity categories 244 is an activity topic selection interface for selecting a recreational activity category from a plurality of recreational activity category. As illustrated in FIG. 30, the candidate activities window 256 is an activity display interface from displaying description data describing at least one recreational activity associated with the selected recreational activity category. As illustrated in FIG. 30, the recreational activity selection input is operated by activating the “select” button in 258. As illustrated in FIG. 30, the selected activity display is the activity stack 240.

The embodiment of FIG. 30 includes the optional feature of a location selection interface for selecting a location from a plurality of locations. As illustrated in FIG. 30, the location selection interface is implemented with the toggling mechanism 252, and the activity display interface (e.g. the candidate activities window 256) is operative to display description data associated with recreational activity category in the selected location. Thus, as illustrated in FIG. 30, wherein Paris, France is displayed, only bungee activities in Paris are displayed, and bungee activities in Lyon are not displayed.

It is noted that the system as described in FIG. 30 thus segregates displayed activities according to locations (e.g. Paris or Lyon). Thus, in some embodiments, the system includes a sorting mechanism for sorting the displayed recreational activities by location.

In exemplary embodiments, the description data in the candidate activities window 256 includes at least one of graphical description data, an image of a person engaging in a said recreational activity, a video of said recreational activity, a textual description of said recreational activity, a photo-album and a textual description of said recreational activity, pricing information, duration or estimated duration information, location information, and rating information.

Optionally, the system includes an activity display populator for computing a selection of at least one recreational activity. For the example of FIG. 30, this is implemented by the “System's recommendation” 250 feature. It is noted that in FIG. 30 in the event that the user requests the “System's recommendation,” the candidate activity display is operative to display at least one recreational activity “computed” or selected by the recommendation of the systems.

It is now disclosed for the first time a method for querying recreation activities, including receiving only once identifiers of a plurality of destinations and presenting a single screen including a plurality of recreational activities, each recreational activity associated with a respective location among the received destinations, where the recreational activities segregated according to their respective locations.

FIG. 30 also provides an exemplary illustration for this presently disclosed system. The destinations are thus entered only once in FIG. 20, and by toggling with the toggling mechanism 252 the recreational or tourism activities with the selected location are displayed in the candidate activity display window.

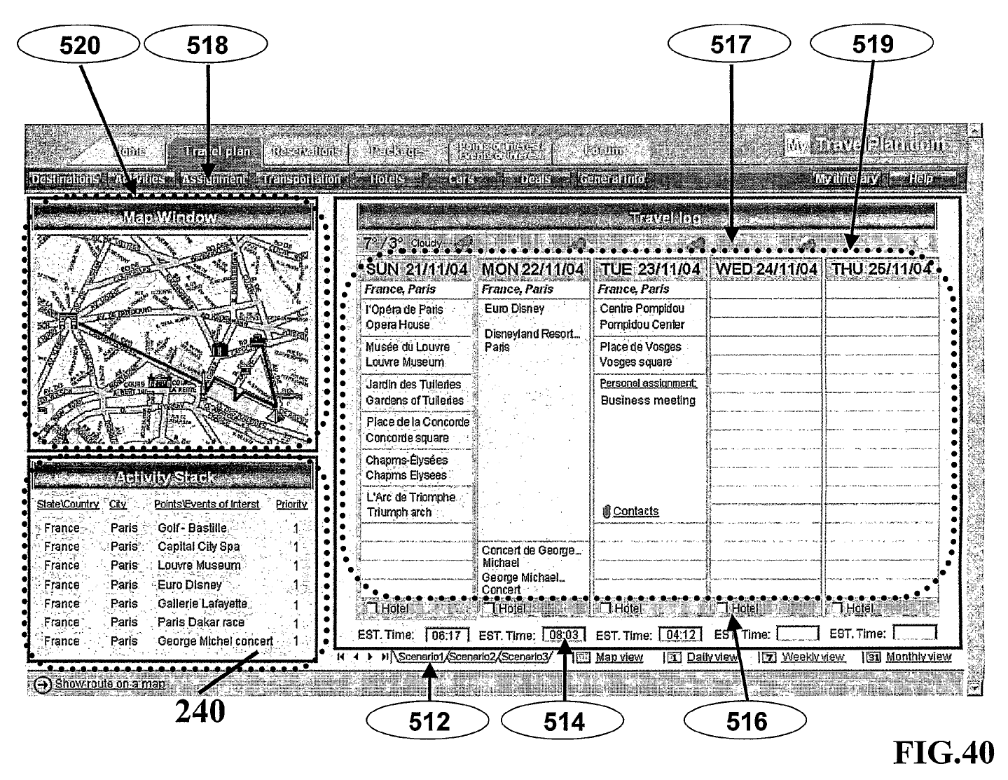

FIG. 40 provides an image of an exemplary user interface for scheduling one or more activities within an “activity stack” 240 within a one or more time interfaces, shown in the scheduling window 519. The scheduling may be performed manually, for example, by dragging and dropping representations of specific activities within the scheduling window 519. Alternatively or additionally, the scheduling is performed using an appropriate scheduling algorithm implemented by the scheduling engine 140.

It is noted that the interface of FIG. 40 is operative to assign or schedule various activities, and the interface of FIG. 40 is activated by selecting the “assignment” tab.

In some embodiments, the computing of a schedule and the selection of activities to schedule is an iterative process, and the travel planning engine 114 includes “recalculate” functionality. One example of this recalculating functionality is the following scenario. A person or group of travelers plan on staying in Paris for several days, and they are not sure whether or not to go to the opera on Sunday or on Monday. The user can manually direct the system to schedule the opera for Sunday, and allow the scheduling engine 140 to compute a schedule of other activities from the activity stack 240 and display the results in the scheduling window 519. Subsequently, the user can manually provide one or more other scheduling directives, such a directive to schedule the opera for Monday, and once more direct the scheduling engine 140 to compute a schedule of other activities from the activity stack. The scheduling user interface as shown in FIG. 40 provides a plurality of scenario toggles 512 allowing the user to analyze the various scenarios. Alternatively or additionally, the travel planning engine 114 includes a scenario analysis engine 148 for analysis of multiple scenarios. Optionally, for each of the multiple scenarios analyzed certain schedule parameters are computed, such as a total budget, a total distance traveled, and the like. The results may be presented for a plurality of scenarios, thus facilitating comparison.

It is noted that the scheduling window displays the time to be scheduled as a plurality of days. This is not specific limitation of the present invention, and alternatively or additionally, other views are provided such as a daily view, a weekly view, and a monthly view.

As shown in FIG. 40, the interface includes an aggregate time window 514 for displaying an estimated total time of scheduled activity for one specific time period (in the example of FIG. 40, this display is provided for each day). Optionally, the user may enter a specific value within the aggregate time window 514, and this functions a specific total time constraint for the scheduling engine 140. Thus, according to some embodiments, specification of a total EST time constrains a maximum amount of time to be schedules. Alternatively or additionally, specification of a total EST time provides a minimum amount of EST time. It is appreciated that for any specified time constraint, or any constraint, may optionally be provided with a tolerance (either from the user or from the system), and any scheduling in accordance with the constraint is in accordance with the constraint and the tolerance.

It is noted that the “aggregate time window” 514 is a particular case for any specific travel resource. Exemplary travel resources include but are not limited to time and budget (e.g. money or any other budgeted resource). For the specific example wherein the window is daily monetary budget, the window (similar to the “aggregate time window” 514) is operative to display amount of money expended by all recreational or tourism activities scheduled on a given day. It is appreciated that this applies to any other specific travel resource.

According to some embodiments, scheduling of a given recreational activity in a given physical location is defined by a choosing of a fixed starting and/or ending time for the recreational activity. For certain recreational activities, the duration of the activity is pre-defined, and scheduling the activity entails only choosing a starting time for the activity. Examples of recreational activities of fixed duration include but are not limited to movies and plays. Alternatively, certain recreational activities are of variable duration, and thus scheduling activities of variable lengths requires choosing both a starting and an ending time. Examples of variable length activities include but are not limited to museum visits, restaurant visits, and certain sporting activities (e.g. baseball games).

In some embodiments, the scheduling optionally includes selecting a location of a recreational and/or tourism activity. In one example, it is desired to see a movie in a given city (e.g. Paris), and the scheduling includes selecting the appropriate theater using appropriate travel criteria, e.g. when a particular movie theater has showings scheduled, location of the particular movie theater, etc.

Thus, in some embodiments, the scheduling is effected in accordance with respective physical locations of the recreational activities. Returning to the movie theater example, if a traveler is scheduled to visit, say, a museum in a certain location within the city, and a certain movie is playing in many locations in the city, a movie theater in proximity of the museum will be preferred and scheduled.

In some embodiments, events of interest having specific starting times are scheduled, for example, a particular baseball game or concert with a fixed starting time. Nevertheless, it is noted that this is not a limitation of the present invention, and in some embodiments, the system is operative to schedule a recreational and/or tourism activity whose starting time is not fixed, e.g. a recreational and/or tourism activity whose starting time is a “free parameter.” Examples of such events include visits to points of interest (e.g. monuments, parks, restaurants, spas, etc). In some embodiments, the “free parameter” is a partially free parameter. For example, if a restaurant has fixed opening hours (say, 9 AM until 11 PM), then the starting time of a meal in the restaurant cannot be scheduled for, say, 2 AM, but could be scheduled for any time during opening hours.

In some embodiments, time parameters of activities (e.g. opening hours, expected duration of a museum visit, etc). In some embodiments, a predicted duration parameter of a recreational and/or tourism activity is stored in the storage 120 and/or obtained from the external data sources 118. In one example, it is known that visitors to a specific art exhibition at a museum are most likely to spend 4 hours at this exhibitions.

In some examples, determining, for scheduling purposes, determining a duration of a recreational and/or tourism activity with variable duration entails predicting a duration. For example, one or more databases providing activities data may note how long the average visit is to an specific museum exhibit or sporting event. In some embodiments, other statistical duration data (e.g. duration standard deviation) is available.

Constraint Management

In some embodiments, the travel planning engine within the travel planning subsystem 114 includes a constraint handler, and the travel planning engine is operative to select and/or schedule and/or recommend a recreational and/or tourism activity in accordance with one or more constraints. Constraints can be derived from a number of sources, including constraints associated with a traveler's limitations (e.g. a budget, time or dietary constraint), constraints derived from a traveler's preferences (e.g. a traveler constrains the system to schedule at least 30% of time during a given week to be dedicated to Japanese culture), and constraints associated with one or more recreational and/or tourism activities (e.g. an opening hours constraint), constraints derived from a scheduling of more than one activity (e.g. a scheduling conflict), constraint associated with activity support resources (e.g. flight and/or hotel and/or rental car availability) sand constraints associated with a traveling party of more than one person traveling together.

Exemplary constraints include but are not limited to hard constraints (e.g. constraints that must not be violated under any circumstance, e.g. a “must see” directive to visit a famous landmark in a certain city), soft constraints (e.g. constraints that may violated under certain circumstances) and periodic constraints (e.g. a constraint associate with an event that occurs more than once on a periodic basis, for example, a happy hour in a bar that would occur every seven days or every twenty-four hours).

Exemplary constraints include but are not limited to resources constraints (e.g. time, money, frequent flier miles), budget constraint (e.g. a budget limitation during a specific time period, in a specific geographical area, a budget constraint related to tourism and/or recreational activities, a constraints related to a specific type of activity, e.g. a commitment not to spend more than $100 a day in restaurants, and a constraint related to activity support expenditures (e.g. flight ticket budget)), an absolute requirement constraint (e.g. a visit to Paris must include Euro-Disney, or a requirement to only stay in a certain hotel chain), appointments that cannot be changed (e.g. an absolute commitment to visit a rock concert that occurs on only one day), corporate policy constraints, availability to the public (e.g. availability of a recreational activity, e.g. seats to a sporting event or availability of an activity support resource, e.g. hotel room availability or flight seat availability), a time constraint (e.g. a commitment to spend no more than five hours a day touring), a location constraint (e.g. a commitment to stay in a specific geographic region), a daylight hours constraint (e.g. one would not engage in a “daylight only” activity after dark), a traffic constraint (e.g. the system would avoid sending someone on a crowded highway during rush hour), a dietary constraint (e.g. the system would only selected and/or schedule and/or recommend eating facilities in accordance with received dietary constraints), a food spoilage constraint, a estimated crowd constraint (e.g. a visit to Euro Disney would be schedule during a time when the lines are expected to be shorter), a child friendliness constraint (e.g. an opera would not be schedule for a traveling part with a small child), a safety constraint (e.g. passengers with safety concerns would be scheduled to avoid dangerous activities and/or regions), opening hours constraint (e.g. no visit to a museum would be scheduled at a time the museum is closed), and a weather constraint (e.g. if the forecast is for rain a visit to a museum would be schedule rather than a visit to an amusement park). One exemplary constraint is a constraint derived from a ratings database (e.g. a person will only eat in restaurants with at least 3 stars).

Exemplary activity support expenditures include but are not limited to accommodations (e.g. hotel) expenditures, transportation expenditures (e.g. flight car rental, gas) and food expenditures. Note that food expenditures can be considered either a recreational and/or tourism activity expenditure (e.g. visiting a restaurant) or an activity support expenditure (e.g. food bought in the supermarket and brought on a skit trip).

One exemplary constraint is an activity category constraint, such as a commitment engage in activities associate with specific categories. On example of an activity category constraint is a commitment to see up to three shopping malls in a week, or to spend 15-25% of the time in malls.

One exemplary constraint is a probabilistic constraint, e.g. a weather constraint based on a 20% chance of rain.

Exemplary constraints also include commitments to attend events of interest (EOI) or places of interest (POI). Alternatively or additionally, the constraint is a commitment related to custom activities that are not necessarily tourism and/or recreational activities. One example of a custom activity is a business meeting. According to this example, a business travelers also wishes to utilize some time for recreational activity. According to this example, the system would avoid scheduling recreational and/or tourism activities that conflict with the business meeting.

One exemplary constraint is an aggregate time constraint (e.g. a commitment to spend no more than 8 hours a day touring) and a time interval constraint (e.g. a commitment to be back in the hotel by 6 PM).

One exemplary constraint relates to compatibility in travel needs for a plurality of individual travelers. For example, in a party of two traveling together, a first person enjoys Japanese cultures and a second person enjoys volleyball games. According to this example, instead of scheduling the first person to go to the best Japanese art museum in the city, a lesser Japanese art museum is selected because of its proximity to a scheduled volleyball game.

There is no limitation on how the constraints enter the system. In some embodiments, the constraints are received through a user interface. Alternatively or additionally, the constraints are obtained from an external database 118. Alternatively or additionally, the constraints are based on historical data.

There is no limitation on how constraints are handle by the system. In some embodiments, constraint-violating activities are not scheduled. Alternatively or additionally, a user is alerted of the constraint violation and given the opportunity to override this violation.

Scheduling in Accordance with Recreational Activity and/or Travel Services Pricing

In some embodiments, the scheduling and/or activity selection and/or activity recommendation is effected in accordance with activity pricing and/or activity support resource pricing. In one example, a museum with a low admission price and a high rating is preferred and selected and/or schedule.

In some examples, the scheduling is effected in accordance with a travel product bundling price. In one example, a traveler initially plans on spending 3 nights in Paris and 4 nights in Lyon. The hotel in Paris has a special deal wherein someone who stays for three night can stay a fourth night at a 75% discount (e.g. bundling between the first three nights and the fourth night). In this situation, the system is operative to recommend that the traveler spend a fourth night in Paris, and to schedule recreational and/or tourism events in Paris during the extra day gained in Paris. It is appreciated that, according to this example, the system would only add the extra night in Paris subject to availability of appropriate transportation (e.g. flights).

There is no limitation in how the relevant pricing information enters the scheduling system. In one example, the travel planning engine is operative to access relevant web sites or databases such as a travel commodities cost database. In one example, the travel planning engine is operative to access a live feed.

Furthermore, it is noted that the notion of “scheduling according to price” also applies to free or substantially free of charge recreational and/or tourism activities. In some embodiments, the planning engine is operative to identify and schedule and/or select free activities in order to fill a specific time period.

It is noted that embodiments of the present invention provide for scheduling and/or selecting and/or recommendation of recreational and/or tourism activities in accordance with any travel benefit parameter and not just in accordance with price. One exemplary a “travel convenience parameter.” For example, if during the course of a day a traveler or group of travelers are scheduled to engage in a plurality of recreational and/or tourism activities, it is more convenient that the traveler minimizes the traveling distance and/or time between the activities. Consider the example where a person is to engage in four recreational and/or tourism activities during a single day, where a first two activities are close to each other and far from a second two activities, which are also close to each other. One example of scheduling in accordance with the “travel convenience parameter” is scheduling the first two events in the morning and scheduling the second two events in the afternoon, obviating the need for unnecessary travel. It is appreciated that the aforementioned example is a simple non-limiting example of scheduling in accordance with proximity of activities as a “travel convenience parameter.”

Another example is a decision to prefer one museum in proximity over the hotel where a person is staying over a superior museum located further away.

It is noted that travel benefit parameter are not limited only to the recreational and/or tourism activity. In some embodiments, the travel benefit parameter relates to an activity support resource such as flights or hotels. Thus, according to one example, museums located in proximity of a luxurious hotel are preferred. In one example, connecting flights that do not require changing airports in a single metropolitan area are prefer, and recreational and/or tourism activities are selected and/or scheduled accordingly.

Other examples of travel benefit parameters include but are not limited to frequent flier miles and travel cost parameters.

Another exemplary parameter is a user preference for an activity or a priority assigned to an activity (e.g. a user directive to prefer sporting events with specific teams).

In some embodiments, the recreational and/or tourism activities are selected and/or scheduled in accordance with a plurality of competing travel benefit parameters. Examples of competing travel parameters include but are not limited to non-compatible preferences between people traveling together and a simultaneous need for inexpensive and convenient travel options.

In some embodiments, information about membership to travel clubs is provided, and the pricing is provide in accordance with travel club membership. It is noted that this feature is not limited to the specific embodiments associated with activity scheduling.

Scheduling of Partially Stochastic Recreational and/or Tourism Activities

In some embodiments, the scheduling includes effecting a probabilistic computation process related to duration likelihoods. In this case, the duration of the activity is not pre-determined (e.g. at least partially stochastic) and is only known as some sort of likelihood function. Relevant examples includes, say, visits to restaurants where it is not necessarily known in advance how long the parties will stay at the restaurant. Another example is a baseball or soccer game, where the duration of the game is not known in advance. Nevertheless, it is possible that, say, the average duration, the standard deviation of the duration or other probabilistic parameters are known in advance, and the scheduling is effected in accordance with these probabilistic or stochastic parameters.

Thus, in some embodiments, the scheduling does not absolutely fix a starting and ending time for a recreational activity, but rather provides a time range for both the starting and ending time and optionally likelihood parameters for when the activity specifically starts and ends.

It is noted that probabilistic scheduling is not limited only to the specific case of non-predetermined duration of activities. In some embodiments, the travel time and/or travel route between the physical locations of respective activities is also not a fixed parameter, and is only known as probabilistic function. This can be due to a number of factors, including but not limited to traffic patterns, flight delays and the like.

Alternatively or additionally, activity duration and/or travel time between activities has a probabilistic element due to the behavior factors of the one or more participants engaging in the scheduled recreational activities. In one example, a scheduled visit to an art museum is supposed to last 3 hours but participants elect to remain an extra hour. In another example, people driving between two cities are impressed by the landscape and elect a “leisurely trip” rather than traveling at the speed predicted by the system.

According to some embodiments of the present invention is a “recalculate feature.” In one example, this feature is useful when an activity duration and/or a duration of travel times deviates from a predicted value and/or a scheduled value and/or a most likely value. In some embodiments, the person engaging in the recreational activity accesses the system the system is operative to automatically recalculate a schedule in accordance with location parameter

In some embodiments, the travel planning engine is operative to select and/or schedule a recreational and/or tourism activity having a non-definite feasibility. One example is a concert where it is known that there is a 20% that the traveler will be able to acquire tickets. If the user indicates a preference for attending the concert, the system is operative to schedule the system and to optionally schedule contingency recreational and/or tourism activities.

Routines for Selecting Tourism and/or Recreational Activities for Scheduling

According to some embodiments, the travel planning subsystem or engine includes an activity selection engine 144, and the selection of the activities to be schedules is carried out at least in part in accordance with the selection computed by the activity selection engine 144.

In some embodiments, the selection is carried out at least in part in accordance with a user preference. In some embodiments, the selection is carried out in accordance with a geographic location. In one example, the user indicates a preference for Japanese culture without specifying actual recreational and/or tourism activities related to Japanese culture. The activity selection engine 144 selects from internal storage 120 and/or an external information source 118 related activities such as Japanese museums, restaurants, sporting events, etc. relevant for the targeted geographic locations.

Exemplary user preferences include but are not limited to user travel goals (e.g. a preference that the purpose of a trip is to study 19^{th} century history of a certain region) and user constraint preferences (e.g. a preference to avoid outdoor activities).

In some embodiments, the activity selection engine 144 is operative to select recreational and/or tourism activities according to a proximity parameter of a first recreational activity to another recreational activity. Thus, in one example, if a recreational activity at a given address (e.g. tour of Empire State Building) is scheduled or possibly scheduled for a certain time, then other recreational and/or tourism activities near the address (e.g. near the Empire State Building) are selected for scheduling.

In some embodiments, the selection is in accordance with a “user profile” of a recreational activity. As used herein, a “user profile” is a profile of the typical user or patron of the recreational and/or tourism activity. For example, if the activity is a Mozart concert, this is appropriate for a “classical music” profile or a “European culture” profile. Thus, in some embodiments, similarities, between user preferences (e.g. preferences of travelers) and typical “user profiles” of recreational activities are analyzed, and activities having appropriate “user profiles” are selected. Thus, according to this example, even if a user does not explicitly specific Classical Music Activities, a Mozart concert could be selected if the relevant fits the profile of a typical patron of Mozart concerts.

In some embodiments, the selection of the one or more tourism and/or recreational activities is performed according to a rating of the activity.

In some embodiments, the selection of the one or more tourism and/or recreational activities is performed according to the computed schedule. In one example, a certain number of activities are selected and scheduled. According to this example, a visit to a museum is schedule for 8 AM-11 AM, and a visit to a sporting event is scheduled from 2 PM-4 PM. In accordance with this schedule, other activities are selected to “fill” the three hour time block in between the museum and sporting event.

In some embodiments, tourism and/or recreational activities are selected in accordance with other previously selected and/or scheduled tourism and/or recreational activities. In one example, a user visits an art museum in the morning and attends a classical music concert in the afternoon. According to this example, a fine restaurant with a “user appropriate” compatible with the taste of the other scheduled activities is select, rather than a fast food restaurant or a facility such as a HardRock® café.

In some embodiments, a user may supply certain numerical directives for selecting and/or scheduling activities. In some embodiments, a user specifies a number, or a minimum number, or a maximum number of activities from a given category to be selected and/or scheduled during a certain time period (e.g. during a day, in a morning, over a two day period, etc). Thus, in one example, a user specifies that during a three day period, two sporting events will be selected and/or scheduled, where the activity category is “sporting events.”

Alternatively or additionally, the user selects an activity category mixture directive, for example, a directive to spend 30% of the time (or 30% of the number of activities) on cultural events, 50% of the time on sporting events, and 20% of the time in eateries.

In some embodiments, the activity mixture directive activity mixture directive is a directive to schedule and/or select at least a minimum number or at most a maximum number of said recreational and/or tourism activities from a given activity category, e.g. at least 3 activities from Japanese culture during a time period.

In some embodiments, the activity mixture directive activity mixture directive is a directive to schedule and/or select at least a minimum number or at most a maximum amount of time of said recreational and/or tourism activities from a given activity category, e.g. at least 3 hours on Japanese culture during a time period.

In some embodiments, the activity mixture directive activity mixture directive is a directive to schedule and/or select at least a minimum number or at most a maximum certain of fraction of scheduled time of said recreational and/or tourism activities from a given activity category, e.g. at 20% of the activity time on Japanese culture during a time period.

In some embodiments, activities are selected and/or scheduled with a history of a traveling party (e.g. a person or group of persons). Thus, in one embodiment, a traveling person prefers extreme sports during a first vacation scheduled in February, and during a second vacation scheduled later in the year (e.g. August), extreme sports activities are selected and/or scheduled.

Hybrid Scheduling

Some embodiments of the present invention provide for “hybrid” scheduling, e.g. scheduling carried out using both the scheduling routines of the scheduling engine as well as directives received during user interventions.

Thus, according to some embodiments, the access interface is operative to receive additional travel planning directives and the schedule is computed in accordance with the received additional travel planning directives.

According to one example, dinner is scheduled in a three-star restaurant, the user “interferes” and manually selects a better (e.g. five star) restaurant. Optionally, the user can send such a directive after a travel plan is produced, and the system generates an updated travel plan.

In some embodiments, the user is not given “free reign” to manually change the activities as he pleases, and the travel engine includes budget monitors which provide an error message or otherwise in event that the user intervenes and exceeds a certain budget (e.g. detection of a constraint violation).

Execution of the Travel Plan

As noted above, generation of the travel plan does not necessarily end once the travel plan is first generated. In some embodiments, the travel plan is a re-generated during “execution” of the travel plan. In one example, a connecting flight is missed and a user arrives at his destination six hours late. According to this example, a schedule of recreational and/or tourism activities is modified in accordance with the reduced amount of time to spent in the city. This obviates the need for a user to have to re-adjust his or her schedule. This re-scheduling can be automatic, or the user can be prompted with appropriate re-scheduling options.

Examples of events that can cause re-scheduling during plan execution include but are not limited to detected events (e.g. a location devices indicates that someone is detained in traffic), an updated user preference (e.g. during the course of a trip, a user indicates that he does not want to spend so much time attending Japanese cultural events), and a user effected scheduling of a scheduled recreational activity (e.g. a user “cancels” attending a certain sporting event and the system schedules other events during the same time slot).

In some embodiments, the scheduling engine receives relevant information from a live feed. In one example, a user is on a “waiting list” for a fine restaurant. When the live feed indicates that a reservation has now become available, the system reschedules accordingly.

Public Transportation Information

In certain embodiments, the travel plan optionally includes information about traveling between a location of a travel support resource (e.g. hotel) and another travel support resource (e.g. bus stations), and/or information about a travel between a travel support resource (e.g. an airport) and a location of a recreational and/or tourism activity.

It is noted that this information is not limited to street map directions for driving or walking, but optionally includes public transportation usage information for traveling between the desired location.

Thus in some embodiments, the travel plan includes information about traveling along one or more routes between a first recreational activity and a second recreational activity.

In some embodiments, the at least one route is at least in a part a public transportation route, and the information includes public transportation information about traveling along said public transportation route using public transportation.

In some embodiments, the public transportation information includes at least one of information about transferring between one mode of transportation and another mode of transportation, information about multi-leg train routes, information about multi-leg bus routes, information about navigation within a public transportation terminal, information about navigation within an airport, and information about proximity between a public transportation station and a said recreational activity.

Referring again to FIG. 40, it is noted that the user interface of FIG. 40 also includes components for reserving activity support resources such as the “hotel” checkbox 516 for specifying if a hotel room is desired for a specific day. Checking or un-checking the “hotel” checkbox is operative to enable the system to select and/or schedule recreational and/or tourism activity in accordance with need for or lack of need for the hotel. In some embodiments, the interface provides a “Rental Car” option per day, wherein selecting or deselecting this option is operative for scheduling in accordance with the present or absence of a rental car.

The map window 520 is operative to display geographic locations of various recreational and/or tourism activities. In some embodiments, the map window 520 is operative to display geographic locations of other important locations of interest such as hotels, airports and other locations associated with activities support resources. Although the map window 520 presents geographical inform on a map, any interface for displaying geographical location information is appropriate.

It is now disclosed for the first time a method of scheduling a plurality of recreational activities. The presently disclosed method includes graphically displaying geographical location information about a plurality of recreational activities through a user interface, each recreational activity associated with a respective displayed geographical location, receiving through the user interface location identifications of a plurality of said displayed geographical locations (e.g. by pointing on a location in the map window), each identification operative to specify a respective associated recreational activity and scheduling within a given time period at least some specified recreational activities.

Although the map window 520 is an exemplary interface for graphically displaying geographical location information, this is not a limitation of the present invention. Furthermore, as shown in FIG. 40, the activity stack 240 displays the association of each activities with a geographical location. The activity stack 240 displays City and Country information, though it is appreciated the in some embodiments, tourism and/or recreational activities are associated with a more specific location within a city and/or country. Thus, in some embodiments, granularity of said displayed geographical location is a sub-metropolitan granularity.

As shown in FIG. 40, geographical information may be specified by pointing to a location within the map window 520, and optionally dragging and dropping the associated activity to the scheduling window 519, though this is an example, and should not be construed as limiting.

In some embodiments, user interface is operative to display feasibility information about at least one said recreational activity. Examples of “feasibility information” include but are not limited to feasibilities related to cost feasibility, scheduling conflict feasibility, and feasibility to travel between two points in a given time.

It is noted that the scheduling user interface as shown in FIG. 40 provides a plurality of scenario toggles 512 allowing the user to analyze the various scenarios.

It is now disclosed for the first time a scheduling system including a storage for storing data about a plurality of recreational activities, each respective recreational activity associated with a respective physical location, an access interface for receiving at least one time interval (e.g. to specify the plurality of time blocks in 519, from 21, Nov. 2004 until 23, Nov. 2004), a scheduling interface for scheduling of a selected sub-plurality of recreational activities within the at least one time interval, scheduling window operative for scheduling a plurality of scheduling scenarios, and a toggling mechanism for toggling between said scenarios.

Scheduling of “Custom Activities” Such as Meetings

It is noted that the interface of FIG. 40 is not limited to recreational and/or tourism activities. Optionally, the interface of FIG. 40 is also operative to schedule (manual and/or computed schedule) of custom activities. Custom activities are personalized activities that one or more parties need to engage in at a specified time or times. Unlike recreational and/or tourism activities, they are not necessarily recreational or tourist by nature, and are personalized to a traveler and/or group of travelers. Exemplary custom activities include but are not limited to business meetings, personal meetings, family meetings, and religious services. In some embodiments, the travel planning engine is operative to schedule and/or select and/or recommend tourism and/or recreational activities in accordance with specified custom activities.

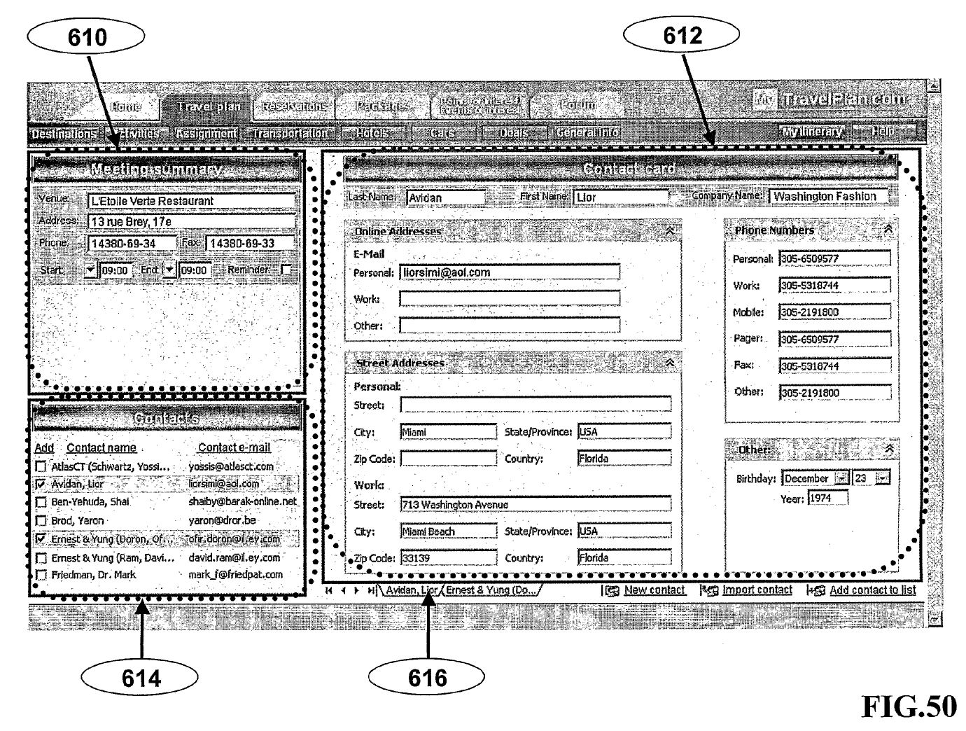

FIG. 50 provides an interface for managing custom activities. The interface includes a contact card window 612, a meeting summary window 610, and list of contacts 614, and a contact toggle 616 operative to display a specific contact card within the contact card window 612.

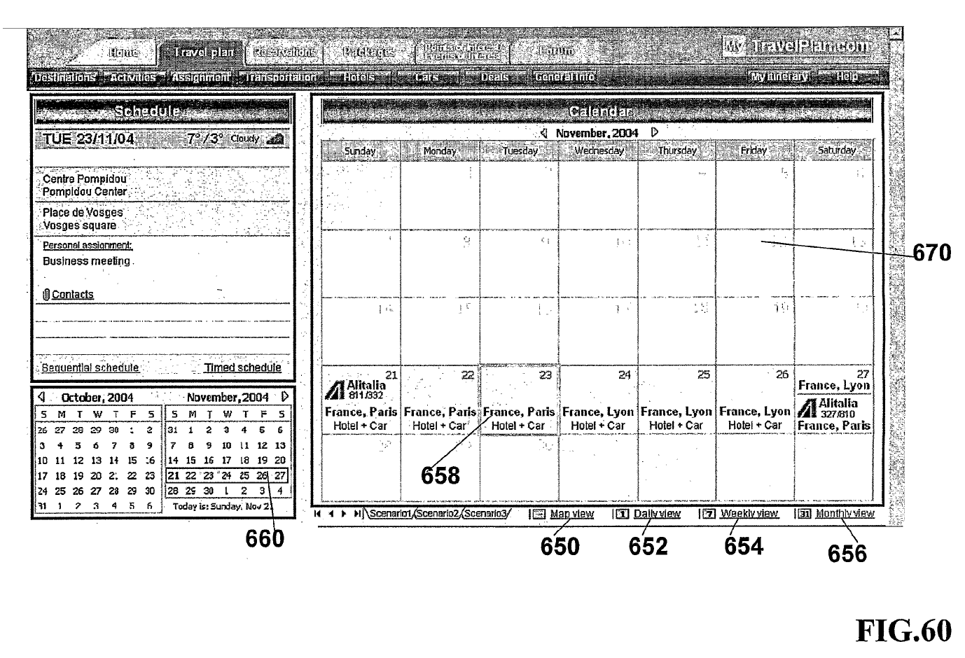

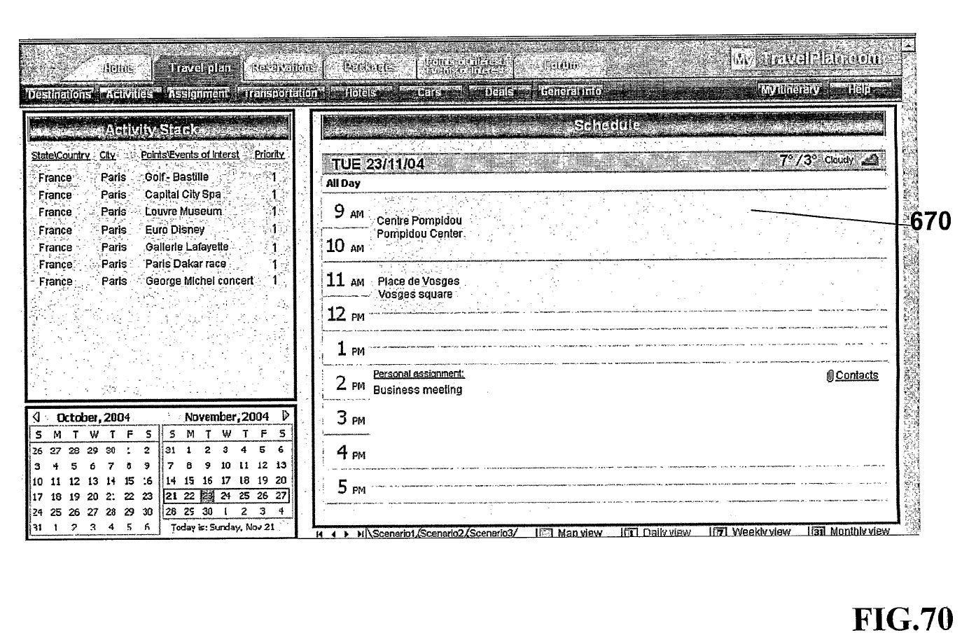

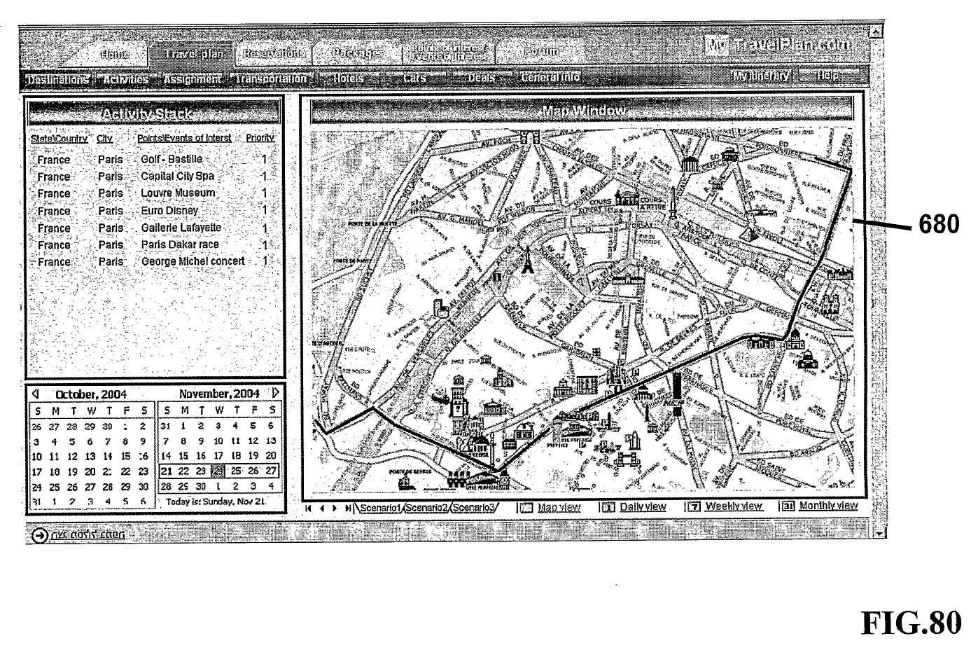

It is noted that the scheduled activities as displayed in FIG. 40 are displayed in a so-called “weekly view.” FIG. 60 provides an image of the a monthly view of the same activities. Thus, according to some embodiments of the present invention, the access interface includes a view presenter for presenting the scheduled tourism and/or recreational and/or custom activities according to a view selected from a plurality of views. For the exemplary embodiment presented, the available views include the Map View 650 (see FIG. 80), the Daily View 652 (see FIG. 70), the Weekly View 654 (see FIG. 40), and the Monthly View 656. In each of the aforementioned views, the interface is optionally operative for scheduling activities and/or viewing scheduled activities.

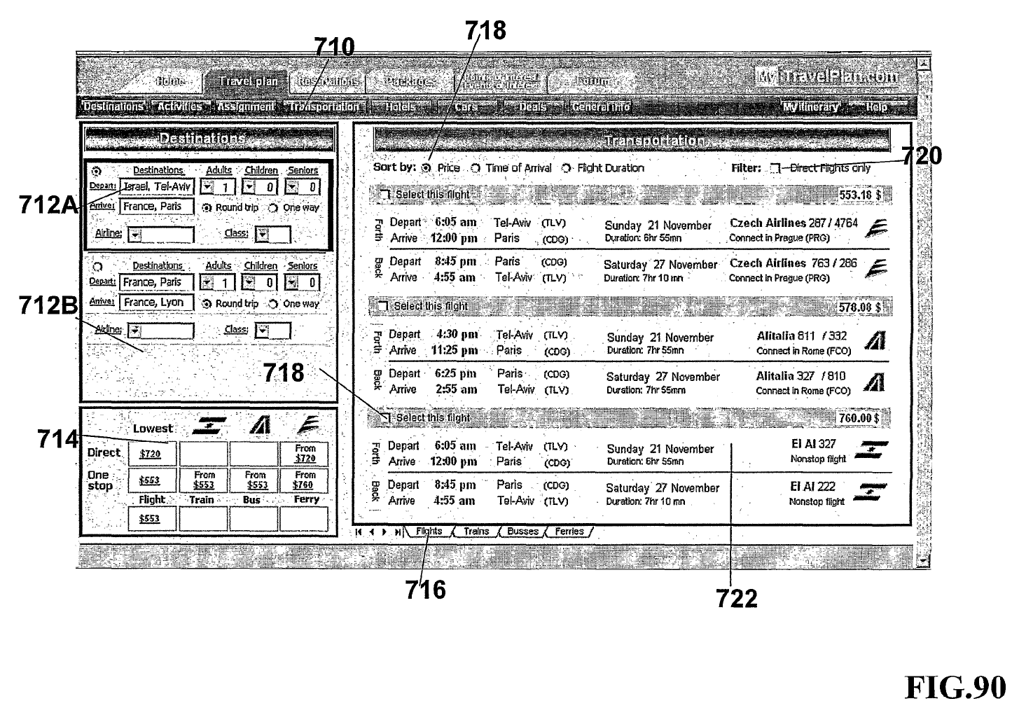

In some embodiments, the present invention relates to systems and methods for obtaining pricing and/or route information for travel between destinations. FIGS. 90-100 present exemplary interfaces for obtaining pricing and/or route information for travel between destinations.

FIG. 90 provides a user interface displaying information related to a multi-leg journey having at least two travel legs. As shown in FIG. 90, there are two legs to the journey, where the first leg (leg window 712A) is Tel-Aviv to Paris, and the second leg (leg window 712B) is Paris to Lyon. The relevant travel information is displayed in the journey display window 722. This inforination can be sorted 718 by price, time of arrival, and flight duration. This information can be filtered according to direct or indirect flights.

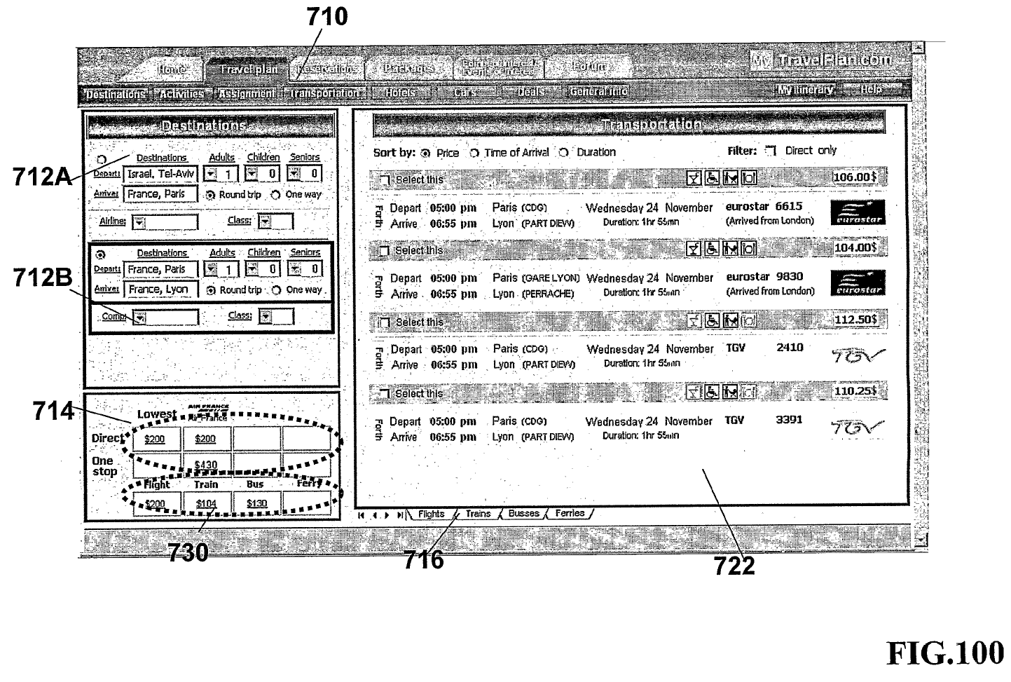

Because the Tel-Aviv to Paris leg is activated in FIG. 90, the travel display window 722 only includes transportation information about the leg from Tel-Aviv to Paris. Toggling a different leg (e.g. Paris to Lyon), as shown in FIG. 100, is operative to display information about transportation between Paris and Lyon. The system also includes a transportation mode toggle 716 for displaying transportation according to the active transportation mode. As shown in FIG. 90, the “Flights” mode is activated. It is noted that in FIG. 90 that there are no busses, ferries or trains between Tel Aviv and Paris, and thus the “Flights” mode is the only relevant mode.

As shown in FIG. 100, the “trains” mode is activated, and the transportation in the display window 722 is train transportation. It is noted that there are also flights between Paris and Lyon.

The interface as shown in FIGS. 90-100 includes a “flights lowest price” window 714 and an overall lowest price window 730. For the first leg, shown in FIG. 90, the lowest price direct flight is $729 and the lowest price one stop flight is $764. The price comparison of 714 in FIG. 90 is for a plurality of travel vendors (e.g. airlines). As shown in FIG. 730, the lowest-priced flight is $200, the lowest price train is $104, and the lowest price bus is $130.

As shown in FIGS. 90-100, the location interface for specifying the locations associated with the multi-leg journey includes the leg windows 712A-712B. In some embodiments, the “specifying” the at least three locations includes receiving the at least three locations through the interface. Alternatively, the at least three “specified” locations are specifying in another interface context, for example, the destination specification interface of FIG. 20.

As shown in FIGS. 90-100, the travel display window functions as a single leg display interface for displaying information about a single travel leg. As shown in FIGS. 90-100, the toggling between the leg windows 712A-712B functions as the selection mechanism for selecting a travel leg.

It is noted that the interface of FIG. 100 provides for the first time the opportunity to obtain information about traveling between two locations using a plurality of modes of transportation through a single interface or location. There is no need for a user to access this information from a plurality of interfaces or locations, and then to compare prices by himself.

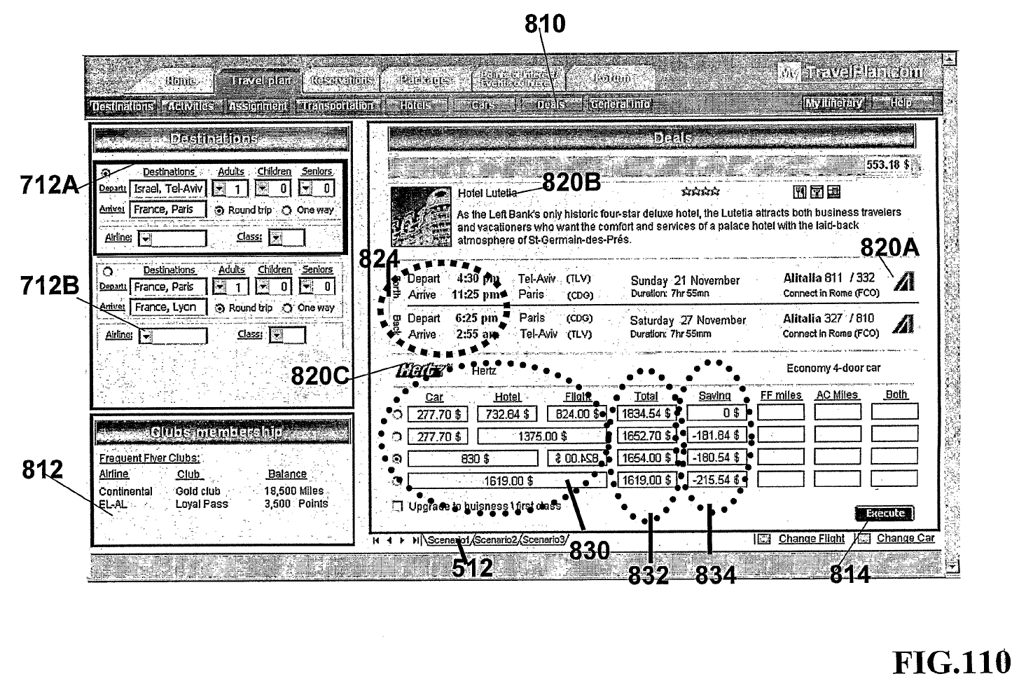

FIG. 110 provides an exemplary interface for obtaining and/or presenting travel deals. The travel deals presented in FIG. 110 include combinations of bundling of three travel services (e.g. a car, a hotel and a flight), shown in the bundling display area 830. For the example of FIG. 110, the departure location is Tel Aviv, the travel destination location is Paris. The vendors for each of the three services are fixed, e.g. the car is rented from car rental vendor with the identifier Hertz® 820C, the flight is provided by Alitalia airlines 820A, and the hotel is the Hotel Lutetia 820B in Paris.

The exact departure time is at 4:30 PM on Sunday November 21, though it is appreciated that in some embodiments, only an approximate departure or travel time need be provided.

As shown in row one of the bundling display 830 (e.g. the first bundling combination), purchasing these three services separately would cost $277.70 for the car only, $732.84 for the hotel only, and $824 for the flight only. The second row of the bundling display 830 (e.g. the second bundling combination) indicates that bundling between the hotel and flight costs $1375 for a total price of $1652.70 (see total column 832) and a savings of $181.84 over the unbundled deal (see savings 834 column). The third row (e.g. the third bundling combination) indicates that bundling the car and hotel only costs $830 for a savings of $180.54. The fourth row indicates that bundling all three services yields a cost of $1619.

It is noted that the deals in the bundling display are displayed on a single screen with each bundling combination. The “target travel” services are car, hotel and flight.

It is noted that in exemplary embodiments, the interface as depicted in FIG. 110 is useful for members of loyalty programs such as travel clubs. For example, even though bundling all three services provides the greatest cost savings, someone with frequent flier miles for a free flight might want to investigate the possibility of bundling the car and the hotel and then compare pricing.

In another example, a user wants to judiciously use his frequent flier points or other membership benefits. The user needs to decided whether or not to use this benefit for a free flight, or to purchase the ticket for the flight, and user the points to upgrade from economy to business class (or to upgrade the car to a better car class). The “unbundling” of the travel resources allows the user to easily examine the feasibility of these two options, and to make an informed decision.

Loyal window 812 displays information associated with travel loyalty program.

A Discussion of Certain Embodiments of a Method and System of Travel Plan

According to some embodiments, the present invention provides systems, methods and computer readable code for generating a unique and customized itinerary for a travel agent, a corporate travel department, an individual traveler or party (hereinafter “ATP). The method or system includes addressing and/or locating a collection of databases and systems (e.g. Geographical Information Systems (GIS) that provides an ATP with a logical way to prepare a complete travel plan which incorporates transportation, accommodation, desired attractions and/or Points of Interest through querying and using the above database and systems.

According to some embodiments, the method further includes attraction and point of interest, hereinafter POI priorities, giving an ATP or a computerized system an efficient way to select an item from one or several items that comprise the same subject, e.g. selecting the Louvre museum among all other museums in Paris, from the database, or to select a “must visit” ranked POI or attraction in general. The method further includes adding facilities close to attractions and POIs e.g. parking lots, to an ATP itinerary, which can be of help to a traveler when arriving at the desired location.

According to some embodiments, the method further includes products and services related to the nature of attractions/POIs, to enable purchase/rental of related equipment, e.g. Ski, Golf.

According to some embodiments, the method further includes an automatic process for preparing a detailed itinerary by selecting categories of interest, with optional quantitative limitations, and/or by selecting specific POIs/EOIs and/or adding non-database POIs/EOIs.

According to some embodiments, the method also includes generating a suggested route for travel between origin and destination, including waypoints along the way, based upon query results and a consideration of scheduling factors related to visits to POI's and EOPs which cannot be changed, priority, geographical location, proximity and availability to the public, such as opening hours and opening days.

According to some embodiments, this portion of the method is performed by a system with a processing engine which will then generate the suggested route for travel between origin and destination, including waypoints along the way, based upon the query results and by giving consideration to rigidity, POIs/EOIs which cannot be changed, priority, geographical location, proximity and availability to the public (e.g. opening hours, opening days).

According to some embodiments, method further includes performing a “What if scenario in every step of preparing the travel plan by saving the current data and showing the effect of the changes on the itinerary's components, such as budget, start-end time, feasibility.

According to some embodiments, the method further includes transferring by various mechanisms, such as cable, infra-red, Wi-Fi, Bluetooth connection of the itinerary and the information related to the POIs/EOIs, to a mobile or hand-held device, such as a Personal Digital Assistant, Smart Phones, laptop computers, Tablet Computers with navigational or Location Based Services capabilities, such as Global Positioning System, Cellular Positioning System for guidance or interaction with Geographical Information Systems.

According to some embodiments, in order to accomplish these methods, the present invention incorporates an itinerary planning computer software system that is complete, integrated and that enables gathering information, and executing queries regarding the travel plan at all stages involved in the making of the itinerary. The software system comprises several sub-systems.

According to some embodiments, the system includes a customer relations management sub-system. The sub-system maintains customer preferences in respect of transportation, such as preferred/rejected airline, preferred seating, preferred meals, rental car companies and car classes etc., accommodations such as hotel chains as well as customer-loyalty program membership data.

According to some embodiments, the system also includes a reservation related sub-system that connects to reservation making systems, such as GDS, CRS and the World Wide Web, for information extraction, e.g. availability checking, reserving, purchasing, and ticketing of tourism services such as flights, airport transfers, hotels, rental cars, busses, trains, cruises and ferries, and POIs. The information extracted from reservation system(s) may be taken as constraints in planning the itinerary. The above information may be used, in its entirety or in any part(s) thereof in the making of an itinerary.

According to some embodiments, the system includes a budget control sub-system that monitors the cost of every reserved or planned service and checks the singular and cumulative amount against preset constraints. Budget exceedance may trigger an increase of the planned budget, reduction in services or in service levels or trip cancellation altogether.

According to some embodiments, the system also includes a geographical information sub-system that can provide a graphical interface for display of user selected locations, POIs and attractions, and can calculate distance between point of origin and point of destination, with or without intermediate waypoints, in various ways shortest route, the scenic route.

According to some embodiments, the system also includes an accounting sub-system that maintains transactions billable to travel agents, customers and suppliers, and produces invoices, receipts, and reports.

According to some embodiments, the system also includes a Passenger Name Record (PNR) sub-system that keeps details of the traveling party, of the reserved services and their status and prints tickets, vouchers and other related documentation.

According to some embodiments, the system and method provide an ATP with an aid to planning, reserving, purchasing and ticketing travel services and present the ATP with data that will enable him or her to construct a tour schedule at a specific destination or between a point of origin and a point of destination, with points of interest along the way, which suits the traveler's preferences in accordance with time, availability and budget constraints.

According to some embodiments, the travel plan with POI/EOI information, facilities in proximity to the POI/EOIs, products and services related to the nature of attractions/POIs and relevant maps, into an itinerary.

According to some embodiments, the system and method provide an ATP with the possibility of synchronizing the generated itinerary with a PDA as an electronic itinerary, with or without navigational or location based service capability, and which includes information related to the itinerary's items.

According to some embodiments, in order to achieve the above, the system uses the reservation related sub-system in order to select specific fights suitable to the traveler based upon financial considerations, or convenience such as direct or connection flights, accommodation arrangements and transportation between waypoints such as flights, trains, and ferries. Travel agents can also perform self-ticketing and/or voucher printing for reserved and confirmed services.

According to some embodiments, the system generates a Passenger Name Record (PNR) for every passenger or party, which includes the passenger name(s), personal details as well as reserved services dates for departure, arrival and destination(s),

According to some embodiments, the system also includes an automatic process of status tracking with decision-making capability (e.g. messaging, ticketing)

According to some embodiments, he system uses the budget control sub-system to define the budget constraints for the selected travel plan. The budget monitors or controls or both expenditures by the traveler of funds during the course of the trip.

According to some embodiments, the funds spent are updated after every expenditure so that the traveler can see what fraction of his or her budget has been spent.

According to some embodiments, the traveler obtains a daily update of funds spent and the fraction of the budget remaining.

According to some embodiments, the system connects with databases, retrieves information from databases, and combines travel information with geographical information using the system engine to produce an itinerary. Every financial transaction is formatted so that it may be read by conventional accounting software.

According to some embodiments, computerized technologies enable gathering, storing and extracting large volumes of data with fast reaction time to updates, resulting in up-to-date information retrieval. The invention makes use of such technologies.

According to some embodiments, the system links changes together so that the traveler may view what impact a change in the itinerary will have on other aspects of the itinerary.

According to some embodiments, the traveler is provided with a list of things that he or she must do as a result of making a change in the itinerary. In another embodiment, last minute changes maybe coordinated with a contact which is displayed on the PDA. According to some embodiments, method and system enable travel providers, and for some embodiments, travelers, to buy ‘shelf space’ in every channel available, making the obtaining of all fares available for sale an achievable task. Travel agents, are able to use multiple systems, thereby having an ability to compare services and fares in as broad a spectrum as all distribution channels provide.

According to some embodiments, a Customer Relations Management Sub-system 116 (see FIG. 10) provides the information about a traveler's demographics (e.g. name, age, gender, address) preferences (e.g. airlines, seats, meals), needs (e.g. wheelchair, special meals) and loyalty programs (e.g. frequent flyer programs and IDs) for assistance in selecting the most suitable service from the services available to the Reservation Related Subsystem 128. A Core System generates a Passenger Name Record (PNR) that contains name(s) and personal details of trip participants (e.g. Date of Birth or age, contact information. Special Services) and to which details of services will be added as they are reserved.

According to some embodiments, the Reservation Related Sub-system 128 connects to external distribution systems, such as Computerized Reservation Systems, Global Distribution Systems and the World Wide Web with requests for service details that meet the travel requirements as given in the access interface 110 and conform to the preferences set forth in the Customer Relations Management Subsystem 116.

According to some embodiments, the services selected by the user are checked by a Budget Control Sub-system 132 for compliance with budget constraints and subject to compliance, a reservation request is sent to the selected distribution system. The request is monitored by an automatic reservation status tracking process with decision-making capabilities (e.g. messaging and ticketing). For distributors that allow self-ticketing of confirmed reservations, tickets or e-tickets may be printed. For services that require vouchers to be handed, appropriate vouchers may be printed (e.g. hotels, rental cars, attractions).

According to some embodiments, databases (internal or external) contain information about points of interest (POI) and events of interest, categorized by location (e.g. Paris), Type (e.g. museums) and Sub-types of POI (e.g. Impressionists), prioritized by location (e.g. highly-recommended), prioritized by type and by sub-type. The databases contain descriptive information, typical duration of visit, days and hours of opening, telephone numbers, geographical location (e.g. geographic coordinates and/or address) and how to get there.

According to some embodiments, the financial aspects of the selected POIs/EOIs are checked by the Budget Control Sub-system 132 for compliance with budget constraints. The Budget Control Sub-system 132 contains limits of expenditure per trip or per service/POI/EOI.

According to some embodiments, the travel planning sub-system connects to the Geographical Information System for constructing a suggested logical route, taking into consideration aspects of geographic location of chosen POI/EOIs and estimated travel time between them.

According to some embodiments, the Accounting Sub-system 130 registers transactions billable to the travel agent and the traveler. The sub-system interfaces with external accounting systems through its own standard interface. The System's Engine 201 generates a trip itinerary and outputs to a printer and/or electronic equipment e.g. handheld devices, such as PDAs and Smartphone devices that are equipped with GPS receivers and/or cellular telephone capabilities.

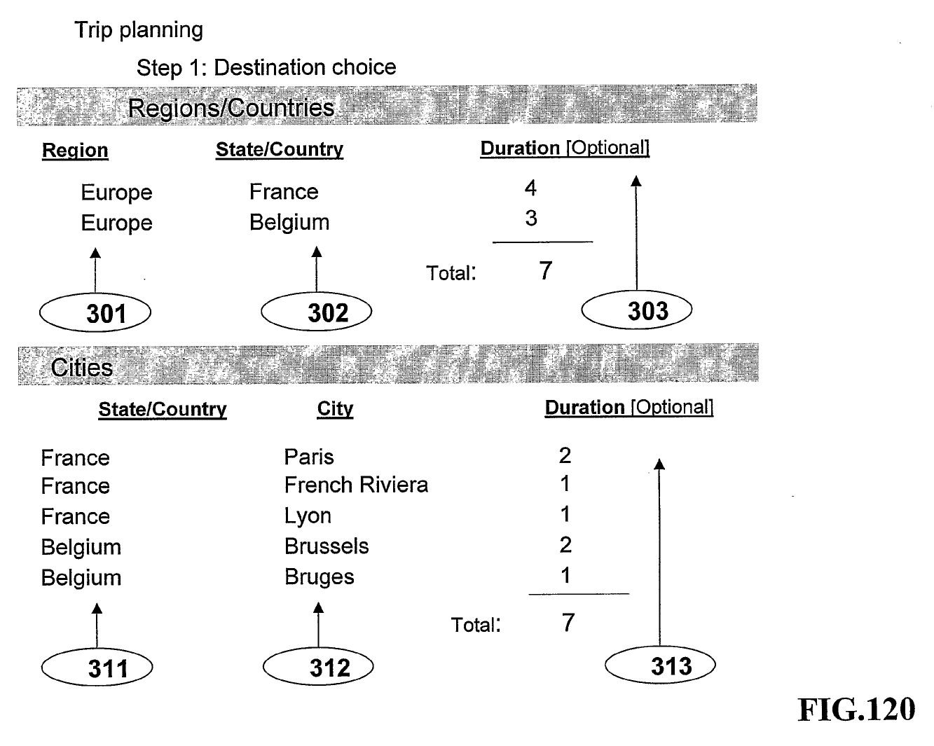

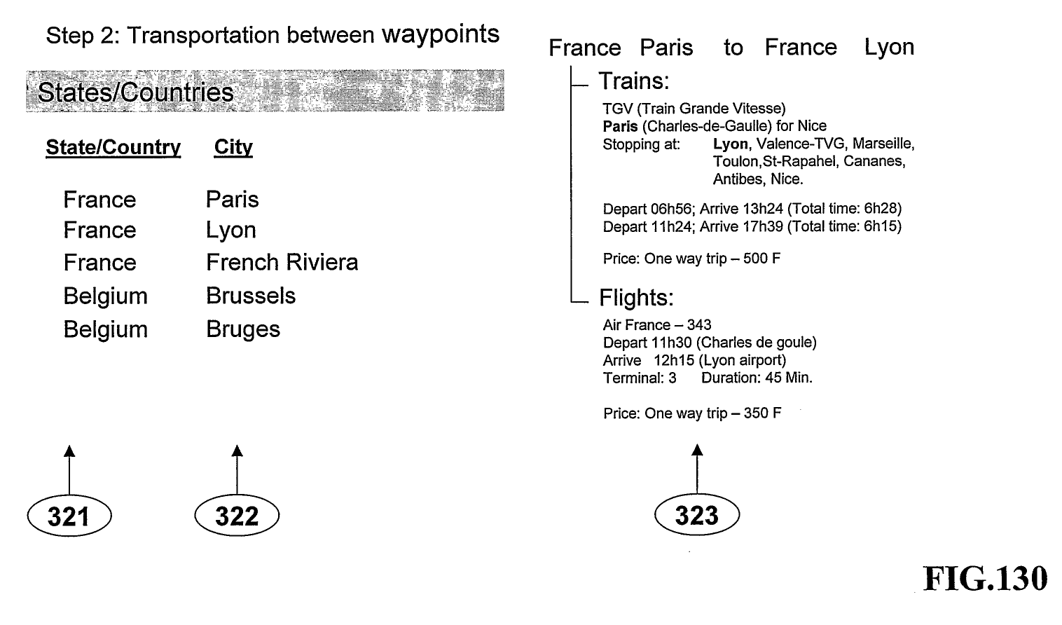

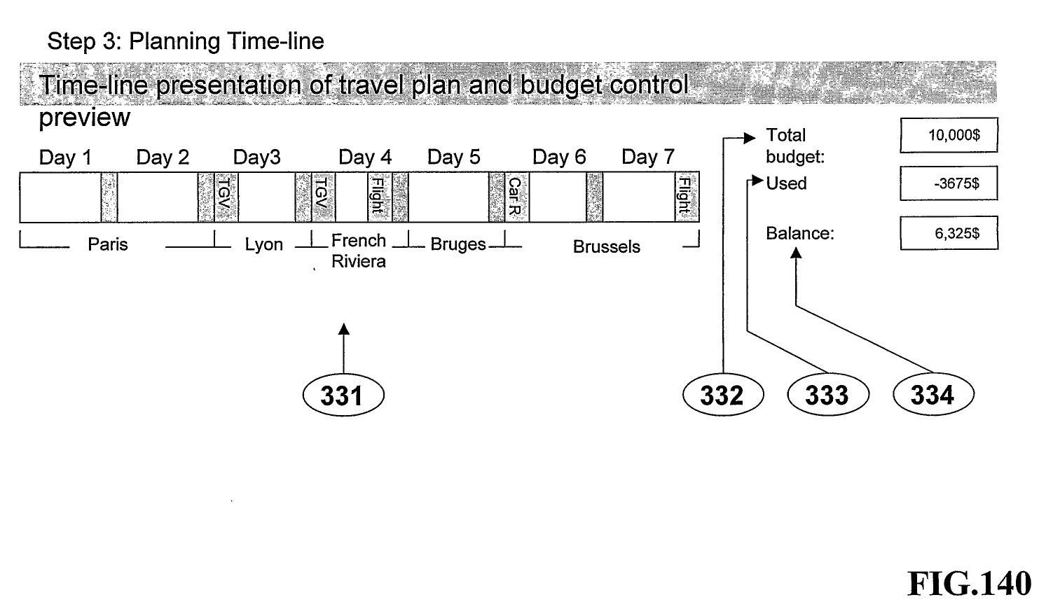

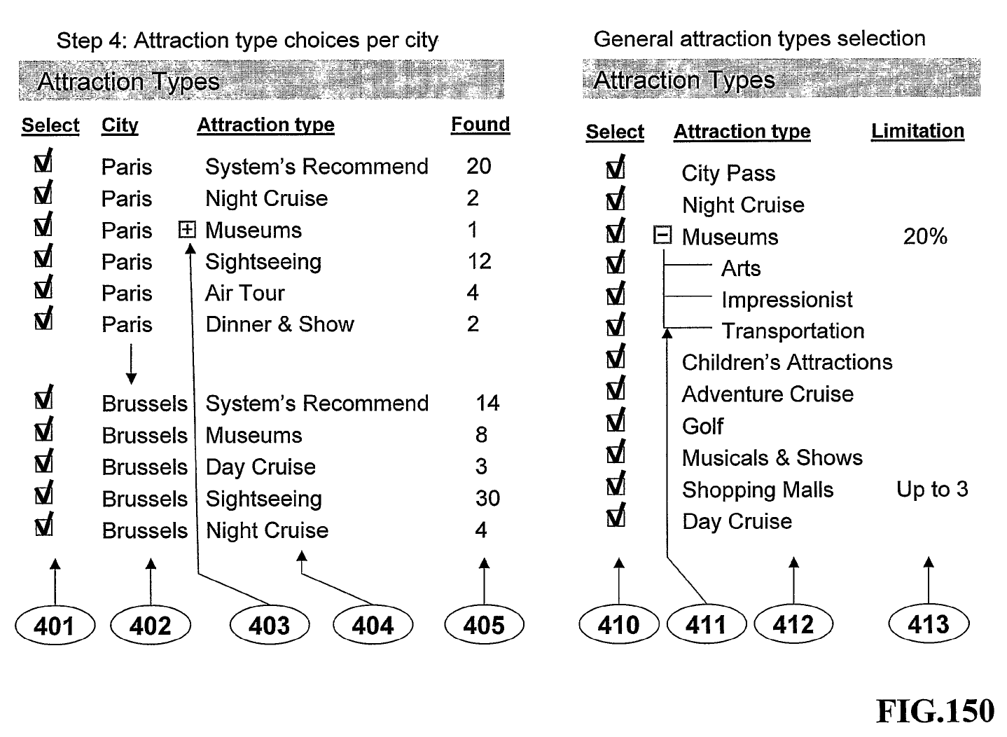

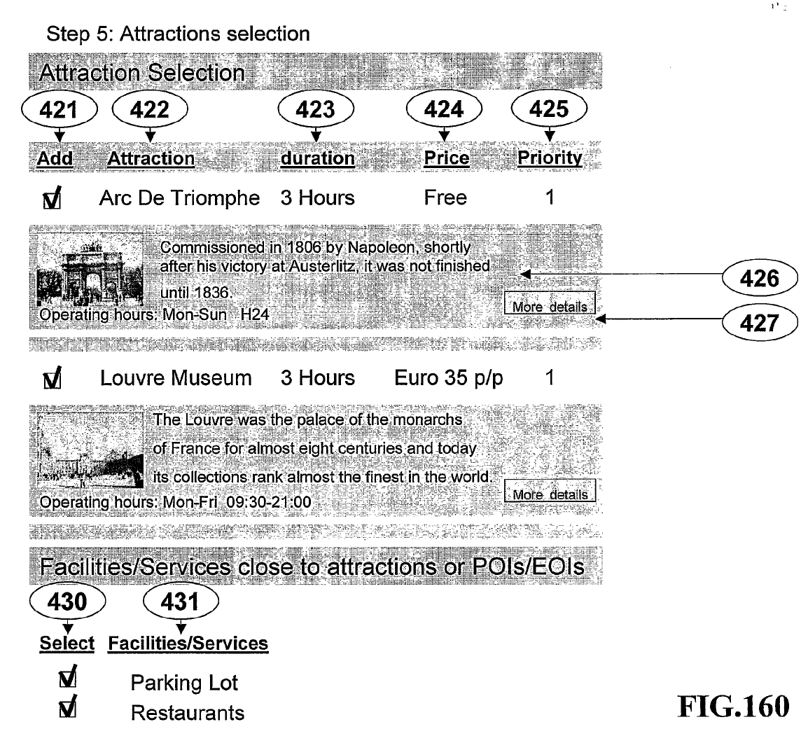

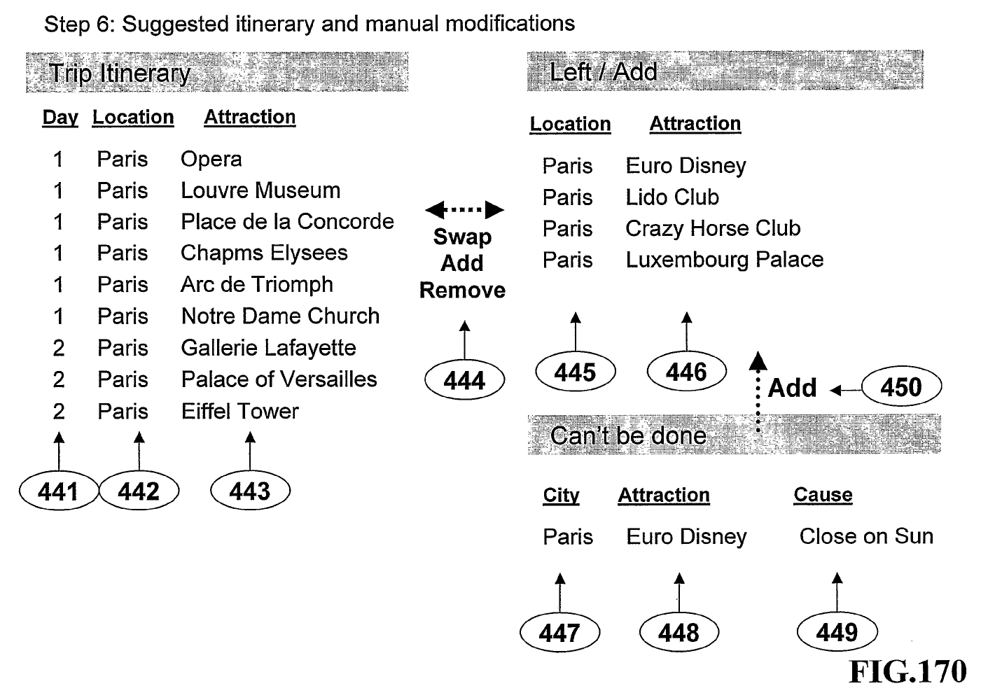

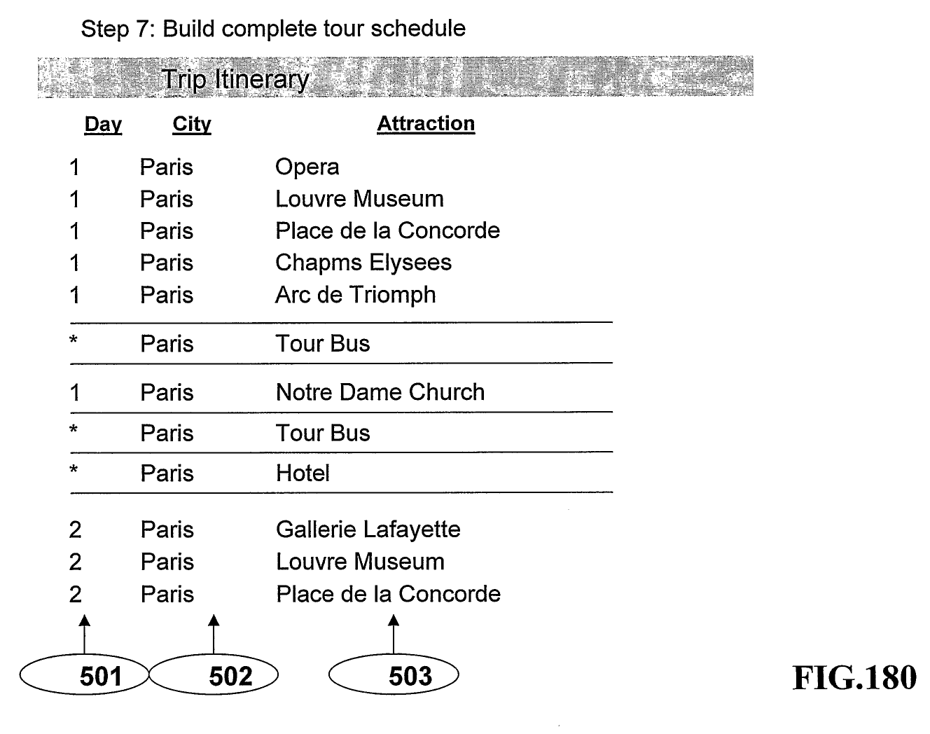

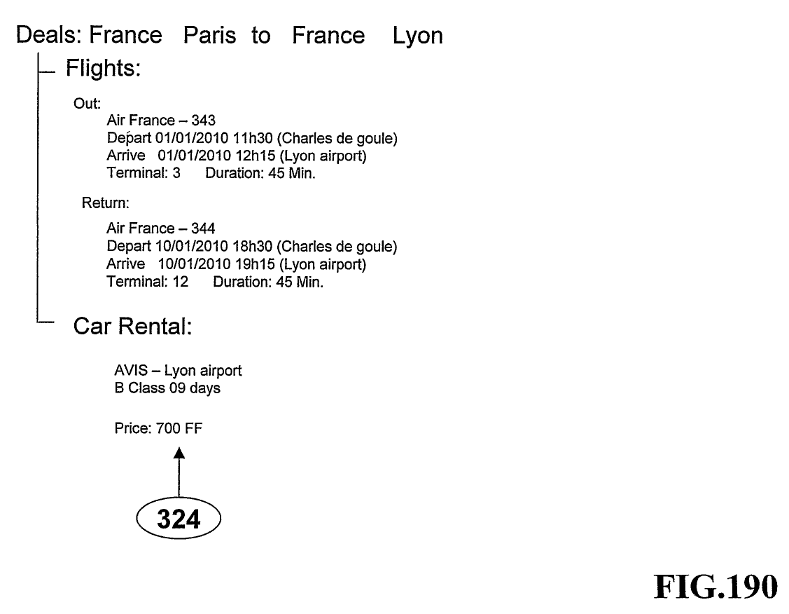

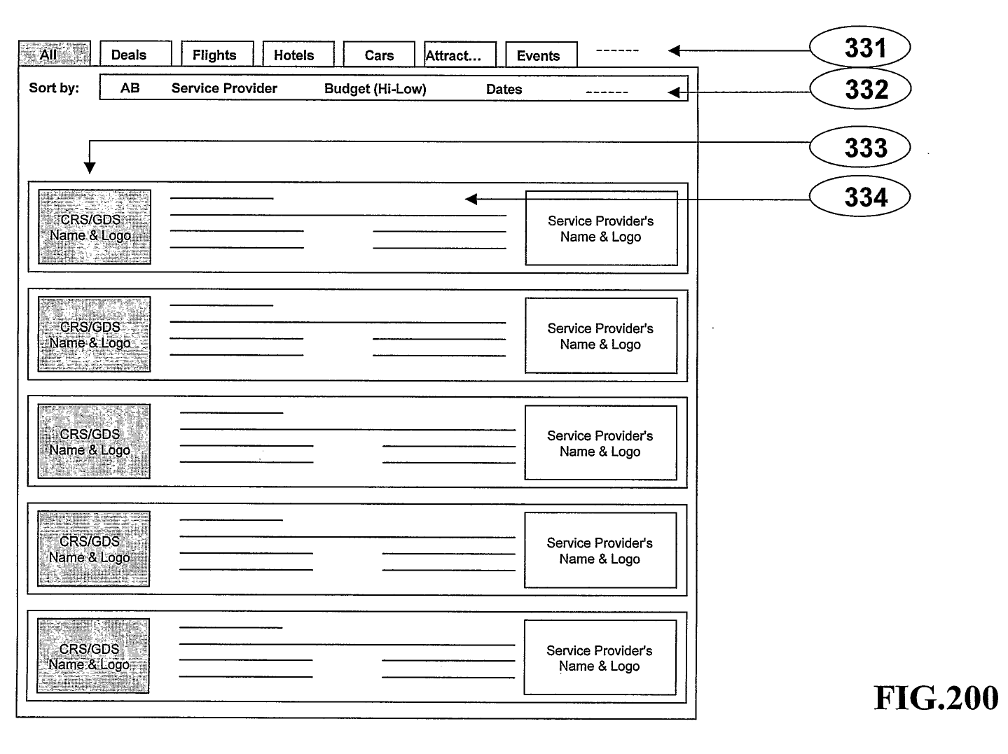

FIGS. 120 through 200 describe the itinerary preparation process. FIG. 120 enables geographic region selection and within a selected region—countries/states selection, textually or graphically. In the textual mode, for every region selected 301 its respective countries/states 302 are filtered.

In the graphical mode, according to some embodiments, the region is selected by clicking its position on a world map resulting in a display of the region map. Clicking a country/state on the region map will enter both region 301 and country/state name 302 into the respective textual input fields. Each country/state selection optionally carries duration of stay 303 in days.

FIG. 130 enables cities selection for each country/state chosen under FIG. 120 textually or graphically. In the textual method, the countries/states 311 are taken from those selected under FIG. 110 and the cities 312 are taken from a list of cities 312 located in the selected countries 311.

In the graphical method, the selection of a country/state displays its map and on the country/state map, the cities to be entered into the textual mode are clicked. Once a city is chosen, an optional duration of stay 303 in days is provided 313. After cities selection, date/time constraints are added, if present.

FIG. 130 displays waypoints as ordered by the system under consideration of date/time dependence and distance between every two points for transportation planning between any two resultant adjacent waypoints (including points of origin and destination). For that purpose, two waypoints at a time are selected, by clicking the map or by name selection. After waypoints order is determined, transportations options between each adjacent waypoint pairs 323 are presented. Transportation options contain every means accessible to and known by the system and include special offers and promotions. Access to the transportation data is carried out by the Reservation Related sub-system 128. Preferred arrival option at each segment's waypoint of destination is selected, checked for time and budget conflicts, and where feasible—reservation availability is checked. Feasible options that have been selected are added to the Activity Queue and where time limit exists, it is attached to the reservation information. At the end of the transportation options selection phase, the selected options are displayed on a time-line FIG. 140.

FIG. 150 enables attraction type selection 401 at each waypoint. The system presents, per waypoint 402, the attraction types 404 that it has information for and also displays the attraction count per each category 405. Where an attraction type 404 contains sub-types, a tree-view 403 is used to display the sub-types. FIG. 160 displays attraction types from which the system selects attractions automatically, according to preference keys given by the user. The user preference is valid for each destination separately or for all the destinations chosen. Attraction Types 412 are displayed for selection where, for each, the user specifies quantitative limitation 413 as a guideline for system's attraction selection. Where an attraction type 412 contains sub-types, a tree-view 411 is used to display the sub-types. Attractions selected under FIG. 150's attraction type are displayed by descending priority order.

FIG. 150 presents selected attractions. For singular selection of each attraction, the attractions are sorted by general preference 425 or by type and sub-type preference. The attraction's display includes the attraction name 422, typical duration of visit 423, entrance fees 424, brief description of the attraction 426 with an optional more detailed description 427 and opening hours 428. Next to each attraction, selectable 430 facilities/services 431 are presented, e.g. parking lots, restaurants, and equipment rental. Each selection is checked for budgetary compliance and if the selection does not deviate from the planned budget 15—it is transferred to the planning queue.

FIG. 140 presents a time-line 331 that conforms to the dates of the beginning and the end of the trip. The time-line consists of swappable daily blocks. For each day, the transportation and accommodation selected are displayed, according to their respective scheduled times. Then, the constrained attractions will be laid out, followed by the attractions planned by the system as may have been trimmed by the user. For each day, the respective location will be presented along the time-line. In addition to the timed presentation, budget related amounts are presented, to include total allocated amount 332, total amount used 333 and balance amount 334.

FIG. 180 presents the trip itinerary as planned, with day numbering 501, 25 location 502 and attraction/activity 503. This presentation may be printed, displayed on a CRT and/or synchronized to a handheld device.

In the description and claims of the present application, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1) A system for generating a travel plan, the system comprising.
a) a storage for storing data about a plurality of recreational activities, each respective said recreational activity associated with a respective physical location;
b) an access interface for receiving at least one time interval; and
c) a travel planning engine for generating a travel plan, wherein said generating includes computing a schedule of a selected sub-plurality of said recreational activities within said at least one time interval.

2) The system for generating a travel plan of claim 1 wherein a plurality of said scheduled recreational activities are each associated with substantially a different physical location.

3) The system for generating a travel plan of claim 1 wherein said schedule is computed in accordance with distances between said respective physical locations of said recreational activities.

4) The system for generating a travel plan of claim 1 wherein at least one said recreational activity is a recreational tourism activity.

5) The system for generating a travel plan of claim 1 wherein said computing of said schedule includes at least one computation selected from the group consisting of selecting a location of said recreational activity, computing a starting time of said recreational activity, computing a finishing time of said recreational activity, and determining a duration of said at least one recreational activity.

6) The system for generating a travel plan of claim 1 wherein said computing of said schedule includes deciding whether or not to schedule a candidate said recreational activity.

7) The system for generating a travel plan of claim 1 wherein said computing of said schedule includes effecting a scheduling decision.

8) The system for generating a travel plan of claim 1 wherein a starting time of at least one said recreational activity is a free parameter, and said computing of said schedule includes determining said starting time.

9) The system for generating a travel plan of claim 1 wherein said sub-plurality of recreational activities includes distinct recreational activities.

10) The system for generating a travel plan of claim 1 wherein said sub-plurality of recreational activities includes recreational activities from a plurality of recreational activity categories.

11) The system for generating a travel plan of claim 1 wherein a time parameter associated with a respective recreational activity is stored in said activity parameter storage.

12) The system for generating a travel plan of claim 11 wherein said time parameter is selected from the group consisting of a set of opening hours, a set of one or more starting times, and a duration time.

13) The system for generating a travel plan of claim 1 wherein at least one said recreational activity is substantially a localized activity.

14) The system for generating a travel plan of claim 1 wherein said substantially localized activity is localized within a specific location within a city.

15) The system for generating a travel plan of claim 1 wherein a duration of a scheduled said recreational activity is determined by said travel planning engine in accordance with a duration parameter received through said access interface.

16) The system for generating a travel plan of claim 1 wherein said activity parameter storage is operative to store a predicted duration parameter of a said recreational activity.

17) The system for generating a travel plan of claim 1 wherein said activity parameter storage is operative to store a probabilistic duration parameter of a said recreational activity.

18) The system for generating a travel plan of claim 1 wherein said scheduling of said recreational activities includes determining a duration of at least one said recreational activity.

19) The system for generating a travel plan of claim 1 wherein said travel planning engine is operative to compute a daily schedule said daily schedule including a plurality of said selected recreational activities.

20) The system for generating a travel plan of claim 1 wherein said travel planning engine is operative to compute said schedule with a granularity of at most three hours.

21) The system for generating a travel plan of claim 1 wherein said travel planning engine is operative to compute said schedule with an hourly granularity.

22) The system for generating a travel plan of claim 1 wherein said travel planning engine is operative to determine a duration of at least one said recreational activity.

23) The system for generating a travel plan of claim 1 further comprising:
d) an output device for outputting said computed schedule.

24) The system for generating a travel plan of claim 1 wherein said access interface is further operative for manual scheduling of at least one selected said recreational activity within said at least one time interval.

25) The system for generating a travel plan of claim 24 wherein said access interface provides access to a plurality of scheduling scenarios.

26) The system for generating a travel plan of claim 24 wherein said computing of said schedule is in accordance with said manual scheduling of said at least one selected said recreational activity.

27) The system for generating a travel plan of claim 1 wherein said travel planning engine includes an activity selection engine and said selection said of sub-plurality is carried out at least in part in accordance with a selection computed by said activity selection engine.

28) The system for generating a travel plan of claim 27 wherein said selection is carried out at least in part in accordance with a user preference.

29) The system for generating a travel plan of claim 27 wherein said activity selection engine is operative to select sub-plurality in accordance with a geographic location of at least one said recreational activity.

30) The system for generating a travel plan of claim 29 wherein said activity selection engine is operative to select sub-plurality in accordance with a proximity parameter of a first said recreational activity relative to a second said recreational activity.

31) The system for generating a travel plan of claim 27 wherein said selection is carried out at least in part in accordance with a rating of a said tourism activity.

32) The system for generating a travel plan of claim 27 wherein said selection is carried out in accordance with said computed schedule.

33) The system for generating a travel plan of claim 27 wherein a selection of a first said recreational tourism activity is carried out in accordance with a second selected said recreational tourism activity.

34) The system for generating a travel plan of claim 27 wherein said selection of said sub-plurality is effected in accordance with an activity category mixture directive.

35) The system for generating a travel plan of claim 27 wherein said selection of said sub-plurality is carried out in accordance with ratings of said recreational activities.

36) The system for generating a travel plan of claim 1 wherein said computing of said schedule is carried out in accordance with ratings of said recreational activities.

37) The system for generating a travel plan of claim 1 wherein said scheduling of said sub-plurality is effected in accordance with an activity category mixture directive.

38) The system for generating a travel plan of claim 37 wherein said activity mixture directive is a directive to schedule at least a minimum number or at most a maximum number of said recreational activities from a given activity category.

39) The system of claim 1 wherein said travel planning engine is operative to compute a plurality of said schedules for a plurality of individuals who are together at a time related to at least one said time period.

40) The system of claim 39 wherein said plurality of schedules is computed in accordance with competing preferences of respective said individuals.

41) The system of claim 39 wherein said preferences are selected from the group consisting of budget preferences, activity type preferences, and activity duration preferences.

42) The system of claim 1 wherein said access interface is operative to receive additional travel planning directives and said schedule is computed in accordance with said received additional travel planning directives.

43) The system of claim 42 wherein said information about a relationship between constraints and said received additional planning directives is transmitted through said access interface.

44) The system of claim 43 wherein said constraints are selected from the group consisting of hard constraints, soft constraints and time-periodic constraints.

45) The system of claim 1 wherein for at least one said activity, said time parameters include a predetermined start time.

46) The system of claim 1 wherein said access interface is operative to receive activity user preferences.

47) The system of claim 1 wherein said travel planning engine includes a constraint handler, and said travel planning engine is operative to effect an operation selected from the group consisting of said computing of said scheduling and said selection of said sub-plurality in accordance with at least one travel constraint.

48) The system of claim 47 wherein at least one said constraint is selected from the group consisting of a resources constraint, budget constraint, an absolute requirement constraint, appointments that cannot be changed, availability to the public, a time constraint, a location constraint, a daylight hours constraint, a traffic constraint, an availability constraint, activity availability constraint and activity support activity constraint, a dietary constraint, a food spoilage constraint, a estimated crowd constraint, a child friendliness constraint, a safety constraint, an opening hours constraint, a calorie constraint, and a weather constraint.

49) The system of claim 48 wherein absolute requirement constraint is received through said access interface.

50) The system of claim 47 wherein said constraint is selected from the group consisting of a soft constraint and hard constraint.

51) The system of claim 1 wherein said access interface is operative to receive information for determining at least in part a said constraint.

52) The system of claim 1 wherein said scheduling is effected in accordance with activity pricing and/or activity support pricing.

53) The system of claim 52 wherein said travel planning engine is operative to access a travel commodities cost database.

54) The system of claim 52 wherein said planning engine is operative to identify and schedule free activities in order to schedule activities for a subset of said time period.

55) The system of claim 52 wherein said travel planning engine is operative to handle travel product bundling pricing.

56) The system of claim 1 wherein said travel planning engine includes a constraint handler, and said travel planning engine is operative to effect an operation selected from the group consisting of said computing of said scheduling and said selection of said sub-plurality in accordance with a value of at least one travel benefit parameter.

57) The system of claim 56 wherein said at least one travel benefit parameter is a plurality of competing said travel benefit parameters.

58) The system of claim 56 wherein said travel benefit parameter is selected from the group consisting of an activity benefit parameter and an activity support benefit parameter.

59) The system of claim 1 wherein at said parameter is a priority parameter of at least one said recreational activity.

60) The system for generating a travel plan of claim 1 wherein said scheduling system is distributed at least in part over a computer network.

61) The system for generating a travel plan of claim 1 wherein said scheduling system is distributed at least in part over a computer network.

62) The system for generating a travel plan of claim 61 wherein said storage device is distributed over a plurality of devices, the system further comprising:
d) a synchronization mechanism operative to synchronize data between said plurality of devices.

63) The system of claim 60 wherein said access interface resides on a plurality of networked devices.

64) The system of claim 63 wherein at least one said networked device is a wireless device.

65) The system of claim 64 wherein said wireless device includes a location positioning system.

66) The system for generating a travel plan of claim 64 wherein said wireless device is selected from the group consisting of a PDA, a cell phone and a personal computer.

67) The system of claim 1 wherein said travel planning engine is operative to update said schedule in accordance with a plurality of travel feedback parameters.

68) The system of claim 67 wherein at least one said travel feedback parameter is selected from the group consisting of a detected event, an updated user preference, and an user-effected scheduling of a said recreational activity.

69) The system of claim 1 wherein said travel planning engine is operative to analyze a plurality of scheduling scenarios.

70) The system of claim 1 wherein said access interface is operative to effect a manual scheduling of at least one said recreational activity.

71) The system of claim 70 wherein said travel planning engine is operative to compute said schedule in accordance with said manually scheduled recreational activity.

72) The system of claim 70 wherein said access interface is further operative to present scheduling suggestions derived from a said computed schedule.

73) The system of claim 70 wherein the system is operative to schedule said recreational activities iteratively, each said iteration including a said manual scheduling and a said computed scheduling.

74) The system of claim 1 further comprising.
d) a data acquisition system for acquiring data related to said recreational activities.

75) The system of claim 74 wherein said data acquisition system is operative to acquire a live feed of said data.

76) The schedule of claim 75 further comprising.
e) an alert system, for alerting a user of updated information related to a said recreational activity.

77) The scheduling of claim 1 wherein said travel planning engine is operative to schedule a said recreational activity having a non-definite feasibility.

78) The system for generating a travel plan of claim 1 wherein said travel engine is operative to compute said schedule in accordance with a geographic location of a said recreational activity.

79) The system for generating a travel plan of claim 78 wherein said travel engine is operative to compute said schedule in accordance with a proximity parameter of a first said recreational activity relative to a second said recreational activity.

80) The system for generating a travel plan of claim 1 wherein said travel plan includes information about traveling along one or more routes between a first said recreational activity and a second said recreational activity.

81) The system for generating a travel plan of claim 80 wherein at least one said route is at least in a part a public transportation route, and said information includes public transportation information about traveling along said public transportation route using public transportation.

82) The system for generating a travel plan of claim 81 wherein said public transportation information includes at least one of information about transferring between one mode of transportation and another mode of transportation, information about multi-leg train routes, information about multi-leg bus routes, information about navigation within a public transportation terminal, information about navigation within an airport, and information about proximity between a public transportation station and a said recreational activity.

83) A scheduling system comprising:
a) a storage for storing data about a plurality of recreational activities, each respective said recreational activity associated with a respective physical location;
b) an access interface for receiving at least one time interval; and
c) a travel planning engine for generating a travel plan, wherein said generating includes making a schedule of a selected sub-plurality of said recreational activities within said at least one time interval, wherein said travel plan includes public transportations directions from one said recreational activity to another said recreational activity.

84) The system for generating a travel plan of claim 83 wherein at least one said route is at least in a part a public transportation route, and said information includes public transportation information about traveling along said public transportation route using public transportation.

85) The system for generating a travel plan of claim 85 wherein said public transportation information includes at least one of information about transferring between one mode of transportation and another mode of transportation, information about multi-leg train routes, information about multi-leg bus routes, information about navigation within a public transportation terminal, information about navigation within an airport, and information about proximity between a public transportation station and a said recreational activity.

86) A method of generating a travel plan, the method comprising:
a) receiving data about a plurality of recreational activities, each respective said recreational activity associated with a respective physical location,
b) receiving at least one time interval; and
c) generating the travel plan, wherein said generating includes computing a schedule of a selected sub-plurality of said recreational activities within said at least one time interval.

87) The method of claim 86 wherein said data is stored in a storage, said storage comprising at least one of volatile memory and non-volatile memory.

88) A computer readable storage medium having computer readable code embodied in said computer readable storage medium, said computer readable code for generating a travel plan, said computer readable code comprising instructions for:
a) receiving data about a plurality of recreational activities, each respective said recreational activity associated with a respective physical location,
b) receiving at least one time interval; and
c) generating the travel plan, wherein said generating includes computing a schedule of a selected sub-plurality of said recreational activities within said at least one time interval.

89) A method of scheduling a plurality of travel activities, the method comprising:
a) receiving activity preferences, location constraints, budget constraints and at least one time period from a user,
b) presenting a plurality of recreational activities satisfying said received activities preferences, said location constraints and said budget constraints,
c) receiving a selected subset of said presented activities,
d) scheduling said selected subset of said activities within said at least one time period.

90) A system for trip planning comprising.
a) an activity topic selection interface for selecting an recreational activity category from a plurality of recreational activity category,
b) an activity display interface from displaying description data describing at least one recreational activity associated with said selected recreational activity category,
c) a recreational activity selection input for selecting at least one said displayed activity;
d) a selected activity display for displaying said selected activities.

91) The system of claim 90 further comprising:
e) a location selection interface for selecting a location from a plurality of locations, wherein said activity display interface is operative to display description data associated with said selected recreational activity category in said selected location.

92) The system of claim 90 wherein said description data includes at least one of graphical description data, an image of a person engaging in a said recreational activity, a video of said recreational activity, a textual description of said recreational activity, a photo-album and a textual description of said recreational activity, pricing information, duration or estimated duration information, location information, and rating information.

93) The system of claim 90 wherein said activity category selection interface is operative for selection of subcategories of said categories, and said activity displayed interface is operative to display recreational activity associated with said selected subcategory.

94) The system of claim 93 wherein said activity category selection interface includes a tree interface for selecting said sub-categories.

95) The system of claim 90 further comprising:
e) a sorting mechanism for sorting said displayed recreational activities by location.

96) A method of presenting information about pricing of at least three targeted travel services, each respective travel service from a different travel category, the method comprising:
a) providing a vendor identifier for each respective travel service;
b) receiving a travel departure location, a travel destination location and an approximate travel time from a user;
c) after said receiving of said travel departure location and said travel destination location, presenting to said user a single screen including a plurality of distinct bundling combinations, at least one said bundling combination including at least one bundling of a plurality of travel services, each said bundling combination operative to supply all of the target travel services.

97) The method of claim 96 wherein said single screen is operative to display said bundling combination in accordance with loyalty program information.

98) The method of claim 96 wherein said single screen includes pricing information about said presented bundling combinations.

99) The method of claim 96 wherein said single screen is operative to display said pricing information in accordance with loyalty program information.

100) The method of claim 159 wherein said single screen includes information about pricing savings associated with one said bundling combination with respect with another said bundling combination.

101) A system for customizing a travel itinerary for a traveler, comprising:
means for sending and receiving data from a plurality of databases; means for selecting points of interest and prioritizing points of interest and means for making reservations; means for selecting events of interest and means for making reservations wherein scheduling and selection of the points of interest and, optionally, events of interest provides the traveler with a trip organization that maximizes efficiency and ease of travel; means for determining cost of travel itinerary; means for controlling costs of the travel itinerary based upon the traveler's budget; means for transmitting the travel itinerary for use by the traveler, and means for managing customer relations.
